(19) United States
(12) Patent Application Publication
(10) Pub. No.: US 2024/0237010 A1
(43) Pub. Date: Jul. 11, 2024

(54) METHOD AND DEVICE IN NODES USED FOR WIRELESS COMMUNICATION

(71) Applicant: Zheng LIU, Shanghai (CN)

(72) Inventor: Zheng LIU, Shanghai (CN)

(73) Assignee: SHANGHAI TUILUO COMMUNICATION TECHNOLOGY PARTNERSHIP (LIMITED PARTNERSHIP), Shanghai (CN)

(21) Appl. No.: 18/611,742

(22) Filed: Mar. 21, 2024

Related U.S. Application Data
(63) Continuation of application No. PCT/CN2022/119615, filed on Sep. 19, 2022.

(30) Foreign Application Priority Data
Sep. 24, 2021 (CN) 202111122572.3

(51) Int. Cl. H04W 72/23; H04W 72/044

(52) U.S. Cl. CPC H04W 72/23; H04W 72/044

(57) ABSTRACT

The node receives a first information block determining a first search space set and a second search space set; and receives a target control signaling and a first signal, the target control signaling determining a first time-frequency resource set, the first signal belonging to the first time-frequency resource set, the PDCCH candidates in the first search space set and the second search space set are correspondingly associated, a first PDCCH is a PDCCH candidate in the first search space set.while a second PDCCH is a PDCCH candidate associated with the first PDCCH in the second search space set, a target time-frequency resource subset comprises one RE, other than the RE(s) occupied by the first signal; whether the first PDCCH is detected is used to determine whether the target time-frequency resource subset comprises one RE occupied by the second PDCCH. This application avoids resource collisions.

### CROSS REFERENCE TO RELATED APPLICATIONS

This application is the continuation of the international patent application No. PCT/CN2022/119615, filed on Sep. 19,2022, and claims the priority benefit of Chinese patent application Ser. No. 20/211,1122572.3, filed on Sep. 24,2021, the full disclosure of which is incorporated herein by reference.

### BACKGROUND

### Technical Field

The present application relates to transmission methods and devices in wireless communication systems, and in particular to a multi-antenna transmission scheme and device in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

The multi-antenna (e.g., Multiple Input Multiple Output, abbreviated as MIMO, multi-Transmission Reception Point (multi-TRP), and multi-panel) techniques make up an integral part in the New Radio (NR) technique. To adapt to more diversified application scenarios and meet higher requirements, a Work Item (WI) on further enhancement of MIMO under NR was approved at the 3GPP RAN #86 plenary to provide support for multi-antenna communications which is more robust, with higher spectral efficiency and more application scenarios.

### SUMMARY

In a multi-antenna system, like the Multi-Transmission Reception Point (Multi-TRP) communications, the robustness of transmission can be enhanced in a way that a same channel or signal is transmitted through multiple transmission reception points. The Multi-TRP transmission of a data channel is supported in Rel-16, and the 3GPP planned to introduce the Multi-TRP transmission of a control channel in Rel-17.

To address the issue of transmission of control channels in a multi-antenna system, the present application provides a solution. It should be noted that the description of the present application only takes the multi-antenna system, especially the multi-TRP (i.e., multi-Transmission Reception Point) transmission system, as a typical application scenario or example; the present application is equally applicable to other scenarios facing similar problems (e.g., scenarios with higher requirements for robustness or coverage of the control channel or scenarios requiring PDCCH linkage in addition to multi-TRP transmission, including but not limited to coverage enhancement systems, Internet of Things (IoT), Ultra Reliable Low Latency Communication (URLLC) networks, V2X, etc.), and similar technical results can be achieved. Additionally, the adoption of a unified solution for various scenarios, including but not limited to multi-antenna systems, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information block, the first information block being used to determine a first search space set and a second search space set, the first search space set comprising at least one PDCCH candidate, and the second search space set comprising at least one PDCCH candidate, the first search space set being different from the second search space set; and
receiving a target control signaling and receiving a first signal, the target control signaling being used to determine a first time-frequency resource set, the first time-frequency resource set comprising multiple REs, and the first signal occupying at least one RE in time-frequency domain, any RE occupied by the first signal in time-frequency domain belonging to the first time-frequency resource set;
herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, whether the target time-frequency resource subset comprises RE(s) occupied by the second PDCCH is determined according to whether the first PDCCH is detected, thereby supporting both REs occupied by two mutually linked PDCCH candidates in being excluded from the resource mapping of the PTRS or the resource mapping of the PDSCH, which avoids collisions between the PTRS or PDSCH and the PDCCH, as well as guarantees the phase tracking performance of PTRS and the decoding performance of PDSCH.

According to one aspect of the present application, the above method is characterized in that a control resource set associated with the first search space set is a first control resource set; a control resource set associated with the second search space set is a second control resource set; quasi co-location of reference signals in the first control resource set is different from quasi co-location of reference signals in the second control resource set.

According to one aspect of the present application, the above method is characterized in that an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

According to one aspect of the present application, the above method is characterized in that a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

In one embodiment, whether an RE occupied by the second PDCCH is avoided by the first signal is determined according to the target value or whether the second PDCCH is monitored or dropped, so that it can be determined whether PDCCH resources are actually occupied according to the blind detection of the PDCCH, unnecessary rate matching or puncturing for resource mapping can be reduced, and the resource utilization and the transmission performance of PTRS or PDSCH can be improved.

According to one aspect of the present application, the above method is characterized in that at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

In one embodiment, the impact of the search space set being discarded due to overbooking is considered in determining whether a PDCCH resource is actually occupied, further reducing unnecessary rate matching or puncturing during resource mapping.

According to one aspect of the present application, the above method is characterized in that the first information block is used to indicate a reference search space set, the reference search space set being one of the first search space set or the second search space set; whether the reference search space set and the second search space set are the same is used to determine whether the target time-frequency resource subset comprises at least one RE occupied by the second PDCCH.

In one embodiment, the occupancy of PDCCH resources is determined according to the indication of the first information block, which provides a unified scheme for different purposes (e.g., the determination of HARQ resources, timing, etc.), streamlines the design, and reduces the standardization workload while supporting PTRS or PDSCH in avoiding PDCCH resources.

According to one aspect of the present application, the above method is characterized in comprising:
receiving a second signal;
herein, the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

The present application provides a method in a second node for wireless communications, comprising:
transmitting a first information block, the first information block used to indicate a first search space set and a second search space set, the first search space set comprising at least one PDCCH candidate, and the second search space set comprising at least one PDCCH candidate, the first search space set being different from the second search space set; and
transmitting a target control signaling and transmitting a first signal, the target control signaling used to indicate a first time-frequency resource set, the first time-frequency resource set comprising multiple REs, and the first signal occupying at least one RE in time-frequency domain, any RE occupied by the first signal in time-frequency domain belonging to the first time-frequency resource set;
herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

According to one aspect of the present application, the above method is characterized in that a control resource set associated with the first search space set is a first control resource set; a control resource set associated with the second search space set is a second control resource set; quasi co-location of reference signals in the first control resource set is different from quasi co-location of reference signals in the second control resource set.

According to one aspect of the present application, the above method is characterized in that an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

According to one aspect of the present application, the above method is characterized in that a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

According to one aspect of the present application, the above method is characterized in that at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

According to one aspect of the present application, the above method is characterized in that the first information block is used to indicate a reference search space set, the reference search space set being one of the first search space set or the second search space set; whether the reference search space set and the second search space set are the same is used to determine whether the target time-frequency resource subset comprises at least one RE occupied by the second PDCCH.

According to one aspect of the present application, the above method is characterized in comprising:
transmitting a second signal;
herein, the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

The present application provides a first node for wireless communications, comprising:
a first receiver, receiving a first information block, the first information block being used to determine a first search space set and a second search space set, the first search space set comprising at least one PDCCH candidate, and the second search space set comprising at least one PDCCH candidate, the first search space set being different from the second search space set; and
a second receiver, receiving a target control signaling and receiving a first signal, the target control signaling being used to determine a first time-frequency resource set, the first time-frequency resource set comprising multiple REs, and the first signal occupying at least one RE in time-frequency domain, any RE occupied by the first signal in time-frequency domain belonging to the first time-frequency resource set;
herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

The present application provides a second node for wireless communications, comprising:
a first transmitter, transmitting a first information block, the first information block used to indicate a first search space set and a second search space set, the first search space set comprising at least one PDCCH candidate, and the second search space set comprising at least one PDCCH candidate, the first search space set being different from the second search space set; and
a second transmitter, transmitting a target control signaling and transmitting a first signal, the target control signaling used to indicate a first time-frequency resource set, the first time-frequency resource set comprising multiple REs, and the first signal occupying at least one RE in time-frequency domain, any RE occupied by the first signal in time-frequency domain belonging to the first time-frequency resource set;
herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, the method in the present application has the following advantages:
the method in this application supports both REs occupied by two mutually linked PDCCH candidates in being excluded from the resource mapping of the PTRS or the resource mapping of the PDSCH, which avoids collisions between the PTRS or PDSCH and the PDCCH, as well as guarantees the phase tracking performance of PTRS and the decoding performance of PDSCH.
the method in this application can determine whether PDCCH resources are actually occupied according to the blind detection of the PDCCH, reduce unnecessary rate matching or puncturing for resource mapping, and improve the resource utilization and the transmission performance of PTRS or PDSCH.
by adopting the method in this application, the impact of the search space set being discarded due to overbooking is considered in determining whether a PDCCH resource is actually occupied, further reducing unnecessary rate matching or puncturing during resource mapping.
the method in this application provides a unified scheme for different purposes (e.g., the determination of HARQ resources, timing, etc.), streamlines the design, and reduces the standardization workload while supporting PTRS or PDSCH in avoiding PDCCH resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block, a target control signaling and a first signal according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first node and a second node according to one embodiment of the present application.

FIG. 5 illustrates a flowchart of radio signal transmission according to one embodiment of the present application.

FIG. 6 illustrates a schematic diagram of a relationship between a first control resource set and a second control resource set according to one embodiment of the present application.

FIG. 7 illustrates a schematic diagram of a relationship between a first PDCCH and a second PDCCH according to one embodiment of the present application.

FIG. 8 illustrates a schematic diagram of a target value according to one embodiment of the present application.

FIG. 9 illustrates a schematic diagram of relationships between a second PDCCH and a first threshold and a second threshold according to one embodiment of the present application.

FIG. 10 illustrates a schematic diagram of a reference search space set according to one embodiment of the present application.

FIG. 11 illustrates a schematic diagram of a relationship between a first signal and a second signal according to one embodiment of the present application.

FIG. 12 illustrates a structure block diagram of a processing device in a first node according to one embodiment of the present application.

FIG. 13 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

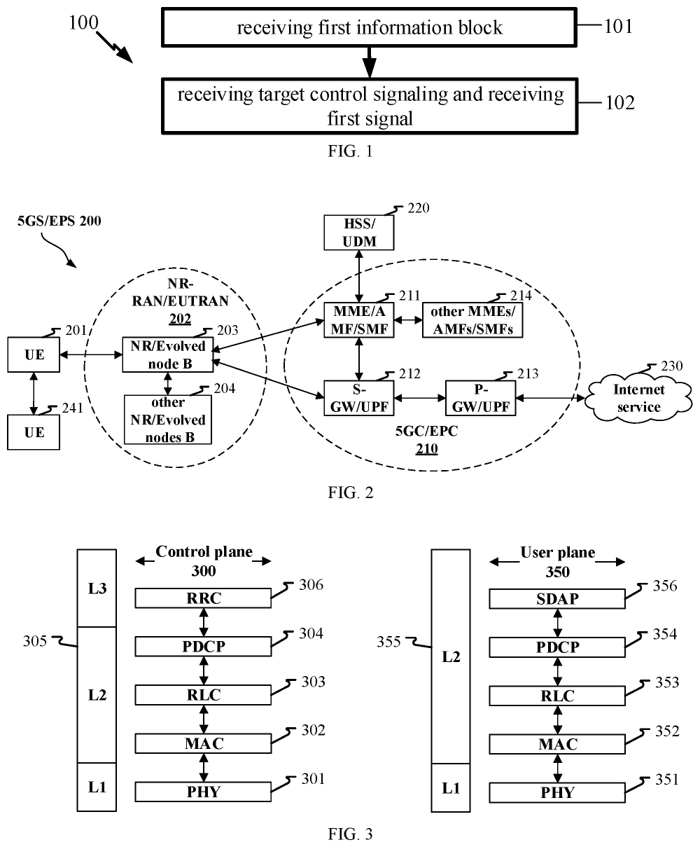

Embodiment 1 illustrates a flowchart 100 of a first information block, a target control signaling and a first signal according to one embodiment of the present application, as shown in FIG. 1. In FIG. 1, each step represents a step, it should be particularly noted that the sequence order of each box herein does not restrict a chronological order of steps marked respectively by these boxes.

In Embodiment 1, the first node in the present application receives a first information block in step 101; the first information block is used to determine a first search space set and a second search space set, the first search space set comprising at least one PDCCH candidate, and the second search space set comprising at least one PDCCH candidate, the first search space set being different from the second search space set; the first node in the present application receives a target control signaling and receives a first signal in step 102, the target control signaling used to determine a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, the first information block is transmitted via an air interface or a wireless interface.

In one embodiment, the first information block comprises all or part of a higher layer signaling or a physical layer signaling.

In one embodiment, the first information block comprises all or part of a Radio Resource Control (RRC) layer signaling or a Medium Access Control (MAC) layer signaling.

In one embodiment, the first information block comprises all or part of a System Information Block (SIB).

In one embodiment, the first information block is Cell Specific or UE-specific.

In one embodiment, the first information block is Per Bandwidth-Part (BWP) Configured.

In one embodiment, the first information block comprises all or partial fields in a Downlink Control Information (DCI) Format.

In one embodiment, the first information block comprises more than one sub-information-block, and each sub-information-block comprised in the first information block is an Information Element (IE) or a field in an RRC signaling to which the first information block belongs; one or more sub-information-blocks in the first information block is/are used to determine the first search space set and the second search space set. In one subsidiary embodiment of the above embodiment, two different sub-information-blocks comprised in the first information block are used to determine the first search space set and the second search space set respectively. In one subsidiary embodiment of the above embodiment, two different sub-information-blocks comprised in the first information block are used to determine the first search space set and the second search space set respectively, and two sub-information-blocks respectively indicating the first search space set and the second search space set belonging to a same IE or List is used to determine that the first search space set and the second search space set are associated.

In one embodiment, the first information block comprises all or partial fields in an Information Element (IE) “BWP-Downlink” in an RRC signaling.

In one embodiment, the first information block comprises all or partial fields in an Information Element (IE) “BWP-DownlinkDedicated” in an RRC signaling.

In one embodiment, the first information block comprises all or partial fields in an Information Element (IE) “PDCCH-Config” in an RRC signaling.

In one embodiment, the first information block comprises all or partial fields in an Information Element (IE) “ControlResourceSet” in an RRC signaling.

In one embodiment, the first information block comprises all or partial fields in an Information Element (IE) “SearchSpace” in an RRC signaling.

In one embodiment, the first information block comprises a field “searchSpacesToAddModList” in an RRC signaling.

In one embodiment, the first information block comprises an IE or a field “searchSpaceLinking” in an RRC signaling.

In one embodiment, the statement in the claims that “the first information block is used to determine a first search space set and a second search space set” includes the following meaning: the first information block is used by the first node in the present application to determine the first search space set and the second search space set.

In one embodiment, the statement in the claims that “the first information block is used to determine a first search space set and a second search space set” includes the following meaning: the first information block is used to indicate, either explicitly or implicitly, the first search space set and the second search space set.

In one embodiment, the statement in the claims that “the first information block is used to determine a first search space set and a second search space set” includes the following meaning: the first information block is used to indicate, either explicitly or implicitly, an index or an identifier of the first search space set and an index or an identifier of the second search space set.

In one embodiment, the statement in the claims that “the first information block is used to determine a first search space set and a second search space set” includes the following meaning: the first information block is used to determine, either explicitly or implicitly, PDCCH candidates comprised in the first search space set and PDCCH candidates comprised in the second search space set.

In one embodiment, the statement in the claims that “the first information block is used to determine a first search space set and a second search space set” includes the following meaning: the first information block is used to indicate that the first search space set and the second search space set are linked/associated.

In one embodiment, the statement in the claims that “the first information block is used to determine a first search space set and a second search space set” includes the following meaning: the first information block is used to indicate the first search space set and the second search space set, and the first information block is used to indicate that the first search space set and the second search space set are linked/associated.

In one embodiment, the statement in the claims that “the first information block is used to determine a first search space set and a second search space set” includes the following meaning: the first information block is used to determine that PDCCH (i.e., Physical Downlink Control Channel) candidates comprised in the first search space set and PDCCH candidates comprised in the second search space set are correspondingly linked/associated.

In one embodiment, the statement in the claims that “the first information block is used to determine a first search space set and a second search space set” includes the following meaning: the first information block is used to determine the first search space set and a search space set associated with the first search space set, the second search space set being a search space set associated with the first search space set.

In one embodiment, the statement in the claims that “the first information block is used to determine a first search space set and a second search space set” includes the following meaning: the first information block is used to indicate, either explicitly or implicitly, an index or identifier of the first search space set and an index or identifier of a search space set associated with the first search space set, an index or identifier of the second search space set being equal to the index or the identifier of the search space set associated with the first search space set.

In one embodiment, the statement in the claims that “the first information block is used to determine a first search space set and a second search space set” includes the following meaning: an index or identifier of the first search space set and an index or identifier of the second search space set are included in a same IE in the first information block.

In one embodiment, the statement in the claims that “the first information block is used to determine a first search space set and a second search space set” includes the following meaning: the first information block is used to indicate that a DCI format carried by one PDCCH candidate in the first search space set and a DCI format carried by one PDCCH candidate in the second search space set are two repetitions of a same DCI format.

In one embodiment, the first information block comprises a first field and a second field, the first field and the second field are two different fields included in an Information Element (IE) “SearchSpace” in an RRC signaling, and the first field and the second field indicate two Search Space Set (SSS) IDs or indexes, respectively.

In one embodiment, the first information block comprises a first field and a second field, the first field and the second field are two different fields included in an Information Element (IE) in an RRC signaling, and the first field and the second field indicate two Search Space Set (SSS) IDs or indexes, respectively.

In one embodiment, the statement in the claims that “the first information block is used to determine the first search space set and the second search space set.” includes the following meaning: the first information block comprises a first field and a second field, the first field and the second field are two different fields included in an Information Element (IE) in an RRC signaling, and the first field and the second field indicate an ID or index of the first search space set and an ID or index of the second search space set, respectively.

In one embodiment, the statement in the claims that “the first information block is used to determine the first search space set and the second search space set.” includes the following meaning: the first information block comprises a first field and a second field, the first field and the second field are two different fields included in an IE“SearchSpace” in an RRC signaling, and the first field and the second field indicate an ID or index of the first search space set and an ID or index of the second search space set, respectively.

In one embodiment, the statement in the claims that “the first information block is used to determine the first search space set and the second search space set.” includes the following meaning: the first information block comprises a first field and a second field, the first field and the second field are two different fields included in an IE“searchSpaceLinking” in an RRC signaling, and the first field and the second field indicate an ID or index of the first search space set and an ID or index of the second search space set, respectively.

In one embodiment, the number of CCE(s) occupied by any PDCCH candidate in the first search space set is equal to one of 1, 2, 4, 8 or 16, while the number of CCE(s) occupied by any PDCCH candidate in the second search space set is equal to one of 1, 2, 4, 8 or 16.

In one embodiment, any PDCCH candidate comprised in the first search space set is a monitored PDCCH candidate; any PDCCH candidate comprised in the second search space set is a monitored PDCCH candidate.

In one embodiment, any PDCCH candidate comprised in the first search space set is a PDCCH candidate being counted for the number of monitorings.

In one embodiment, the first search space set comprises a PDCCH candidate that is a PDCCH candidate not being counted for the number of monitorings.

In one embodiment, any PDCCH candidate comprised in the second search space set is a PDCCH candidate being counted for the number of monitorings.

In one embodiment, the second search space set comprises a PDCCH candidate that is a PDCCH candidate not being counted for the number of monitorings.

In one embodiment, any PDCCH candidate comprised in the first search space set is a PDCCH Candidate that uses one or more DCI Formats or DCI Payload Sizes; any PDCCH candidate comprised in the second search space set is a PDCCH Candidate that uses one or more DCI Formats or DCI Payload Sizes.

In one embodiment, the first search space set comprises only one PDCCH candidate, and the second search space set comprises only one PDCCH candidate.

In one embodiment, the first search space set comprises multiple PDCCH candidates, and the second search space set comprises multiple PDCCH candidates.

In one embodiment, the number of PDCCH candidates comprised in the first search space set is equal to the number of PDCCH candidates comprised in the second search space set.

In one embodiment, the first information block is used to determine the number of PDCCH candidates comprised in the first search space set, and the first information block is used to determine the number of PDCCH candidates comprised in the second search space set.

In one embodiment, the first search space set and the second search space set are both PDCCH Search Space Sets.

In one embodiment, the first search space set is a UE-Specific Search Space Set (USS Set), and the second search space set is a UE-Specific Search Space Set (USS Set).

In one embodiment, the first search space set is a Common Search Space Set (CSS Set), and the second search space set is a CSS Set.

In one embodiment, the first search space set is a Type3 Common Search Space Set (CSS Set), and the second search space set is a Type3 CSS Set.

In one embodiment, the first search space set is a Common Search Space Set (CSS Set), and the second search space set is a UE-Specific Search Space Set (USS Set).

In one embodiment, the first search space set is a UE-Specific Search Space Set (USS Set), and the second search space set is a CSS Set.

In one embodiment, an index of the first search space set and an index of the second search space set are different.

In one embodiment, an ID of the first search space set and an ID of the second search space set are different.

In one embodiment, time-frequency resources occupied by the first search space set and time-frequency resources occupied by the second search space set are different.

In one embodiment, time-frequency resources occupied by the first search space set and time-frequency resources occupied by the second search space set are orthogonal.

In one embodiment, a Control Resource Set (CORESET) associated with the first search space set and a Control Resource Set (CORESET) associated with the second search space set are different.

In one embodiment, a Control Resource Set (CORESET) associated with the first search space set and a Control Resource Set (CORESET) associated with the second search space set are the same.

In one embodiment, the statement in the claims that “the PDCCH candidate(s) in the first search space set and the PDCCH candidate(s) in the second search space set are correspondingly associated” includes the following meaning: the first node in the present application assumes that the PDCCH candidate(s) in the first search space set and the PDCCH candidate(s) in the second search space set are correspondingly associated.

In one embodiment, the statement in the claims that “the PDCCH candidate(s) in the first search space set and the PDCCH candidate(s) in the second search space set are correspondingly associated” includes the following meaning: the PDCCH candidate(s) in the first search space set and the PDCCH candidate(s) in the second search space set can be Soft Combining correspondingly.

In one embodiment, the statement in the claims that “the PDCCH candidate(s) in the first search space set and the PDCCH candidate(s) in the second search space set are correspondingly associated” includes the following meaning: a Payload of DCI format(s) carried by the PDCCH candidate(s) in the first search space set and a Payload of DCI format(s) carried by the corresponding PDCCH candidate(s) in the second search space set are identical.

In one embodiment, the statement in the claims that “the PDCCH candidate(s) in the first search space set and the PDCCH candidate(s) in the second search space set are correspondingly associated” includes the following meaning: DCI format(s) carried by the PDCCH candidate(s) in the first search space set and DCI format(s) carried by the corresponding PDCCH candidate(s) in the second search space set are used to schedule a same signal or channel.

In one embodiment, the statement in the claims that “the PDCCH candidate(s) in the first search space set and the PDCCH candidate(s) in the second search space set are correspondingly associated” includes the following meaning: a DCI format carried by one PDCCH candidate in the first search space set and a DCI format carried by the corresponding PDCCH candidate in the second search space set are used to schedule a same Physical Downlink Shared Channel (PDSCH) or a same Physical Uplink Shared Channel (PUSCH).

In one embodiment, the statement in the claims that “the PDCCH candidate(s) in the first search space set and the PDCCH candidate(s) in the second search space set are correspondingly associated” includes the following meaning: a DCI format carried by one PDCCH candidate in the first search space set and a DCI format carried by the corresponding PDCCH candidate in the second search space set are used to trigger a same Reference Signal (RS).

In one embodiment, the statement in the claims that “the PDCCH candidate(s) in the first search space set and the PDCCH candidate(s) in the second search space set are correspondingly associated” includes the following meaning: a DCI format carried by one PDCCH candidate in the first search space set and a DCI format carried by the corresponding PDCCH candidate in the second search space set are used to schedule a same Transport Block (TB).

In one embodiment, the statement in the claims that “the PDCCH candidate(s) in the first search space set and the PDCCH candidate(s) in the second search space set are correspondingly associated” includes the following meaning: a DCI format carried by one PDCCH candidate in the first search space set and a DCI format carried by the corresponding PDCCH candidate in the second search space set are two repetitions of a same DCI format.

In one embodiment, the statement in the claims that “the PDCCH candidate(s) in the first search space set and the PDCCH candidate(s) in the second search space set are correspondingly associated” includes the following meaning: an ID or index of the first search space set and an ID or index of the second search space set are linked/associated.

In one embodiment, the statement in the claims that “the PDCCH candidate(s) in the first search space set and the PDCCH candidate(s) in the second search space set are correspondingly associated” includes the following meaning: there is a mapping relationship between an ID or index of the first search space set and an ID or index of the second search space set.

In one embodiment, the statement in the claims that “the PDCCH candidate(s) in the first search space set and the PDCCH candidate(s) in the second search space set are correspondingly associated” includes the following meaning: there is an arithmetic relationship between an ID or index of the first search space set and an ID or index of the second search space set.

In one embodiment, the statement in the claims that “the PDCCH candidate(s) in the first search space set and the PDCCH candidate(s) in the second search space set are correspondingly associated” includes the following meaning: the PDCCH candidate(s) in the first search space set and the PDCCH candidate(s) in the second search space set having identical aggregation level and index value are linked/associated.

In one embodiment, the correspondence between the PDCCH candidate(s) in the first search space set and the PDCCH candidate(s) in the second search space set is predefined or configured by signaling.

In one embodiment, any PDCCH candidate in the second search space set corresponds to a PDCCH candidate in the first search space set having the same aggregation level and the same index value.

In one embodiment, the number of PDCCH candidate(s) in the first search space set is equal to the number of PDCCH candidate(s) in the second search space set, and there is a one-to-one correspondence between the PDCCH candidate(s) in the first search space set and the PDCCH candidate(s) in the second search space set.

In one embodiment, the number of PDCCH candidate(s) employing one aggregation level included in the first search space set is equal to the number of PDCCH candidate(s) employing the same aggregation level included in the second search space set, with one-to-one correspondence between the PDCCH candidates respectively included in the first search space set and the second search space set that employ the same aggregation level.

In one embodiment, the PDCCH candidate(s) in the first search space set is(are sequentially) indexed and the PDCCH candidate(s) in the second search space set is(are sequentially) indexed, and a PDCCH candidate in the first search space set corresponds to a PDCCH candidate with the same index value in the second search space set.

In one embodiment, the PDCCH candidate(s) employing one aggregation level in the first search space set is(are sequentially) indexed and the PDCCH candidate(s) employing the same aggregation level in the second search space set is(are sequentially) indexed, and a PDCCH candidate in the first search space set corresponds to a PDCCH candidate with the same index value that employs the same aggregation level in the second search space set.

In one embodiment, PDCCH candidate(s) included in the first search space set in a time window respectively corresponds/correspond to PDCCH candidate(s) included in the second search space set in the same time window according to predefined rules.

In one embodiment, PDCCH candidate(s) included in the first search space set in a slot respectively corresponds/correspond to PDCCH candidate(s) included in the second search space set in the same slot according to predefined rules.

In one embodiment, the PDCCH candidate(s) in the first search space set is(are sequentially) indexed and the PDCCH candidate(s) in the second search space set is(are sequentially) indexed, and a PDCCH candidate in the first search space set corresponds to a PDCCH candidate in the second search space set that has an index value with predefined or signaling-configured offset value.

In one embodiment, the PDCCH candidate(s) in the first search space set is(are sequentially) indexed and the PDCCH candidate(s) in the second search space set is(are sequentially) indexed, and a PDCCH candidate in the first search space set corresponds to a PDCCH candidate with an index value in reverse order in the second search space set.

In one embodiment, the first search space set has a same time-domain configuration as the second search space set.

In one embodiment, the first search space set has an equivalent time-domain period to the second search space set.

In one embodiment, monitoring occasions (MOs) associated with the first search space set respectively correspond to monitoring occasions (MOs) associated with the second search space set.

In one embodiment, monitoring occasions (MOs) associated with the first search space set respectively correspond to monitoring occasions (MOs) associated with the second search space set, any two corresponding MOs belonging to a same slot.

In one embodiment, the target control signaling comprises all or partial fields comprised in a DCI format.

In one embodiment, the target control signaling comprises all or partial fields comprised in a same DCI format carried by one or more PDCCH candidates.

In one embodiment, the target control signaling is carried by only one PDCCH candidate.

In one embodiment, the first node in the present application assumes that the first PDCCH carries the target control signaling, and the first node in the present application assumes that the second PDCCH carries the target control signaling.

In one embodiment, the first PDCCH carries the target control signaling, and the second PDCCH carries the target control signaling.

In one embodiment, the first PDCCH carries a control signaling other than the target control signaling, and the second PDCCH carries a control signaling other than the target control signaling.

In one embodiment, the target control signaling comprises all or partial fields comprised in a same DCI format carried by the first PDCCH and the second PDCCH.

In one embodiment, the target control signaling is carried by a PDCCH other than the first PDCCH and the second PDCCH.

In one embodiment, the target control signaling is not carried by the first PDCCH, nor is the target control signaling carried by the second PDCCH.

In one embodiment, the target control signaling comprises a payload of a DCI format.

In one embodiment, the target control signaling comprises all or partial fields in a detected DCI format.

In one embodiment, the target control signaling comprises all or partial fields comprised in a same DCI format carried by one or more PDCCHs.

In one embodiment, the target control signaling comprises all or partial fields in a DCI format that passes CRC check after being through soft combining and decoding.

In one embodiment, the target control signaling comprises all or partial fields in a DCI format that is successfully decoded.

In one embodiment, the target control signaling comprises all or partial fields in a DCI format carried by a repeatedly transmitted PDCCH.

In one embodiment, the target control signaling is all or partial fields in a DCI format carried by an associated PDCCH.

In one embodiment, the target control signaling is a same PDCCH transmitted once or multiple times.

In one embodiment, the target control signaling is a same PDCCH occupying one or more PDCCH candidates.

In one embodiment, the target control signaling comprises all or partial fields in a scheduling DCI format of the first signal.

In one embodiment, the target control signaling comprises all or partial fields in a scheduling DCI format of a PDSCH to which the first signal belongs.

In one embodiment, the target control signaling comprises all or partial fields in a scheduling DCI format of a PDSCH corresponding to PTRS.

In one embodiment, the statement in the claims that “the target control signaling used to determine a first time-frequency resource set” includes the following meaning: the target control signaling is used by the first node in the present application to determine the first time-frequency resource set.

In one embodiment, the statement in the claims that “the target control signaling used to determine a first time-frequency resource set” includes the following meaning: the target control signaling is used to explicitly or implicitly indicate the first time-frequency resource set.

In one embodiment, the statement in the claims that “the target control signaling used to determine a first time-frequency resource set” includes the following meaning: one or more fields comprised in the target control signaling is/are used to explicitly or implicitly indicate the first time-frequency resource set.

In one embodiment, the statement in the claims that “the target control signaling used to determine a first time-frequency resource set” includes the following meaning: one or more fields comprised in the target control signaling is/are used to explicitly or implicitly indicate time-domain resources comprised in the first time-frequency resource set.

In one embodiment, the statement in the claims that “the target control signaling used to determine a first time-frequency resource set” includes the following meaning: one or more fields comprised in the target control signaling is/are used to explicitly or implicitly indicate the first time-frequency resource set from multiple candidate time-frequency resource sets.

In one embodiment, the statement in the claims that “the target control signaling used to determine a first time-frequency resource set” includes the following meaning: one or more fields comprised in the target control signaling is/are used to explicitly or implicitly indicate frequency-domain resources comprised in the first time-frequency resource set.

In one embodiment, the statement in the claims that “the target control signaling used to determine a first time-frequency resource set” includes the following meaning: one or more fields comprised in the target control signaling is/are used to explicitly or implicitly indicate Resource Blocks (RBs) in frequency domain and symbols in time domain comprised in the first time-frequency resource set.

In one embodiment, the statement in the claims that “the target control signaling used to determine a first time-frequency resource set” includes the following meaning: one or more fields comprised in the target control signaling is/are used to explicitly or implicitly indicate a number of REs comprised in the first time-frequency resource set and a time-frequency position of the comprised REs.

In one embodiment, any two different Resource Elements (REs) in the first time-frequency resource set correspond to a same subcarrier spacing (SCS) and a same length of cyclic prefix (CP).

In one embodiment, the first time-frequency resource set comprises at least one OFDM symbol in time domain.

In one embodiment, the first time-frequency resource set comprises consecutive time-domain resources.

In one embodiment, the first time-frequency resource set comprises discrete time-domain resources.

In one embodiment, the first time-frequency resource set comprises periodic time-domain resources.

In one embodiment, the first time-frequency resource set comprises at least one PRB in frequency domain.

In one embodiment, the first time-frequency resource set comprises consecutive frequency-domain resources.

In one embodiment, the first time-frequency resource set comprises discrete frequency-domain resources.

In one embodiment, the first time-frequency resource set comprises, in frequency domain, at least one Physical Resource Block (PRB) mapped from a Virtual Resource Block (VRB).

In one embodiment, the first time-frequency resource set comprises frequency-domain resources before and after Frequency Hopping (FH).

In one embodiment, the first signal is a baseband signal or a radio frequency signal.

In one embodiment, the first signal includes a reference signal.

In one embodiment, the first signal includes a data signal.

In one embodiment, the first signal is a baseband signal or a radio frequency signal of a Phase Tracking

Reference Signal (PT-RS).

In one embodiment, the first signal is a baseband signal or a radio frequency signal of a PDSCH.

In one embodiment, the first signal includes PT-RS and PDSCH.

In one embodiment, the first signal includes PDSCH Demodulation Reference Signal (DMRS).

In one embodiment, the first signal includes Channel Status Information Reference Signal (CSI-RS).

In one embodiment, the first signal includes PT-RS and CSI-RS.

In one embodiment, the first signal includes at least one of PT-RS, PDSCH, PDSCH DMRS or CSI-RS.

In one embodiment, the first signal includes PT-RS, PDSCH and PDSCH DMRS.

In one embodiment, the first signal includes PDSCH and PDSCH DMRS.

In one embodiment, the first signal carries a Downlink Shared Channel (DL-SCH).

In one embodiment, the first signal is a dynamically scheduling signal.

In one embodiment, the first signal is a Semi-Persistent Scheduling (SPS) signal.

In one embodiment, the first time-frequency resource set is a set of REs assigned to the first signal by the target control signaling.

In one embodiment, the first time-frequency resource set is a set of REs that the target control signaling schedules to the first signal.

In one embodiment, the first time-frequency resource set is a set of REs reserved to the first signal by the target control signaling.

In one embodiment, the first time-frequency resource set is a set of REs that the target control signaling schedules to a PDSCH including the first signal.

In one embodiment, any RE occupied by the first signal belongs to the first time-frequency resource set.

In one embodiment, the first time-frequency resource set is a set of REs that the target control signaling schedules to a PDSCH transmission.

In one embodiment, the first time-frequency resource set is a set of REs that the target control signaling schedules to a PDSCH transmission, and the first signal is a PT-RS of a PDSCH scheduled by the target control signaling.

In one embodiment, the first time-frequency resource set is a set of REs that the target control signaling schedules to a PDSCH transmission, and the first signal is a DMRS and PT-RS of a PDSCH scheduled by the target control signaling.

In one embodiment, the first time-frequency resource set comprises all REs occupied by the first signal and REs occupied by a PDSCH to which the first signal belongs.

In one embodiment, the first PDCCH is a PDCCH candidate.

In one embodiment, the first PDCCH is an actually transmitted PDCCH.

In one embodiment, the first PDCCH is a PDCCH candidate that the first node in this application assumes to carry the target control signaling.

In one embodiment, the first PDCCH is a PDCCH candidate that the first node in this application assumes to carry a given DCI format.

In one embodiment, at least one PDCCH or DCI format is detected on the first PDCCH.

In one embodiment, there isn't any PDCCH or DCI format being detected on the first PDCCH.

In one embodiment, the first PDCCH is a PDCCH candidate detected to be carrying the target control signaling.

In one embodiment, the first PDCCH is a PDCCH candidate monitored by the first node.

In one embodiment, the first PDCCH is a baseband signal or RF signal of a PDCCH.

In one embodiment, the first PDCCH is a PDCCH candidate detected by blind detection according to a DCI format corresponding to the target control signaling.

In one embodiment, PDCCH candidates used for blind detection of the target control signaling include the first PDCCH.

In one embodiment, PDCCH candidates used for soft combining of the target control signaling include the first PDCCH.

In one embodiment, PDCCH candidates used for independent detection of the target control signaling include the first PDCCH.

In one embodiment, time-frequency resources occupied by the second PDCCH are different from time-frequency resources occupied by the first PDCCH.

In one embodiment, a Control Resource Set (CORESET) to which the second PDCCH belongs is not the same as a CORESET to which the first PDCCH belongs.

In one embodiment, control channel elements (CCEs) occupied by the second PDCCH are different from CCEs occupied by the first PDCCH, or scrambling of the second PDCCH is not the same as scrambling of the first PDCCH, or the size of a format of DCI carried by the second PDCCH is not the same as the size of a format of DCI carried by the first PDCCH.

In one embodiment, an index of a control resource set resource pool (i.e., CORESET pool index) to which the first PDCCH belongs is unequal to an index of a control resource set resource pool (i.e., CORESET pool index) to which the second PDCCH belongs.

In one embodiment, quasi co-location of reference signals included in a control resource set to which the first PDCCH belongs and quasi co-location of reference signals included in a control resource set to which the second PDCCH belongs are different.

In one embodiment, the second PDCCH is not detected.

In one embodiment, the second PDCCH is detected.

In one embodiment, PDCCH decoding or DCI format decoding performed on a set of PDCCH candidates including at least the second PDCCH is failed (or a CRC is failed).

In one embodiment, PDCCH decoding or DCI format decoding performed on the second PDCCH is failed (or a CRC is failed).

In one embodiment, occupancy by a PDCCH or DCI format is detected on the second PDCCH.

In one embodiment, occupancy by a PDCCH or DCI format is not detected on the second PDCCH.

In one embodiment, a PDCCH is actually transmitted on the first PDCCH.

In one embodiment, the second PDCCH is a PDCCH candidate that the first node in this application assumes to carry the same control signaling as the first PDCCH.

In one embodiment, the second PDCCH is a PDCCH candidate monitored by the first node.

In one embodiment, the second PDCCH is a baseband signal or RF signal of a PDCCH.

In one embodiment, an aggregation level of the first PDCCH and an aggregation level of the second PDCCH are equal.

In one embodiment, an index of the first PDCCH in the first search space set is equal to an index of the second PDCCH in the second search space set.

In one embodiment, a control signaling carried by the second PDCCH is the same as that carried by the first PDCCH.

In one embodiment, the second PDCCH and the first PDCCH are repetitions of transmission of a same DCI format.

In one embodiment, the second PDCCH and the first PDCCH are repetitions of transmission of a same PDCCH.

In one embodiment, the second PDCCH and the first PDCCH are respectively two PDCCH candidates in the first search space set and the second search space set that are mutually linked/associated.

In one embodiment, the second PDCCH and the first PDCCH are respectively two PDCCH candidates in the first search space set and the second search space set that mutually correspond to each other.

In one embodiment, the first node in the present application assumes that soft combining can be performed between the first PDCCH and the second PDCCH.

In one embodiment, the first node in the present application assumes that soft combining cannot be performed between the first PDCCH and the second PDCCH.

In one embodiment, the first information block is used to indicate whether soft combining between the first PDCCH and the second PDCCH can be performed.

In one embodiment, an information block other than the first information block is used to indicate whether soft combining between the first PDCCH and the second PDCCH can be performed.

In one embodiment, a total number of monitorings performed on the first PDCCH and the second PDCCH is equal to 2.

In one embodiment, a total number of monitorings performed on the first PDCCH and the second PDCCH is equal to 3.

In one embodiment, the first information block in the present application is used to configure the total number of monitorings performed on the first PDCCH and the second PDCCH.

In one embodiment, an information block other than the first information block in the present application is used to configure the total number of monitorings performed on the first PDCCH and the second PDCCH.

In one embodiment, any RE comprised in the target time-frequency resource subset is not occupied or used by the first signal.

In one embodiment, the target time-frequency resource subset is orthogonal to time-frequency resources occupied by the first signal.

In one embodiment, the first signal only occupies REs other than those included in the target time-frequency resource subset.

In one embodiment, there exist overlapped REs between the target time-frequency resource subset and the first time-frequency resource set.

In one embodiment, any RE comprised in the target time-frequency resource subset is an RE that is Rate Matched by the first signal.

In one embodiment, any RE comprised in the target time-frequency resource subset is an RE that is skipped by the first signal.

In one embodiment, the first signal is punctured on any RE comprised in the target time-frequency resource subset.

In one embodiment, at least one RE comprised in the target time-frequency resource subset is Rate Matched by the first signal.

In one embodiment, at least one RE comprised in the target time-frequency resource subset is skipped by the first signal.

In one embodiment, the first signal is punctured on at least one RE comprised in the target time-frequency resource subset.

In one embodiment, any RE comprised in the target time-frequency resource subset is an RE in which a signal other than the first signal is in collision with the first signal.

In one embodiment, any RE comprised in the target time-frequency resource subset is an RE in which a signal other than the first signal is in collision with the first signal that is expected or configured.

In one embodiment, any RE comprised in the target time-frequency resource subset belongs to the first time-frequency resource set.

In one embodiment, the target time-frequency resource subset comprises an RE that does not belong to the first time-frequency resource set.

In one embodiment, the target time-frequency resource subset comprises an RE that belongs to the first time-frequency resource set.

In one embodiment, the target time-frequency resource subset comprises REs that are contiguous in time domain.

In one embodiment, the target time-frequency resource subset comprises REs that are discrete in time domain

In one embodiment, the target time-frequency resource subset comprises REs that are contiguous in frequency domain.

In one embodiment, the target time-frequency resource subset comprises REs that are discrete in frequency domain

In one embodiment, the target time-frequency resource subset comprises at least one RE occupied by the first PDCCH.

In one embodiment, the target time-frequency resource subset does not comprise any RE occupied by the first PDCCH.

In one embodiment, the target time-frequency resource subset comprises at least one RE occupied by the second PDCCH.

In one embodiment, the target time-frequency resource subset does not comprise any RE occupied by the second PDCCH.

In one embodiment, the statement in the claims that “whether the first PDCCH is detected” refers to: whether the first PDCCH is occupied by a detected PDCCH or a detected DCI format.

In one embodiment, the statement in the claims that “whether the first PDCCH is detected” refers to: whether the first PDCCH is detected to be used for transmitting a DCI format.

In one embodiment, the statement in the claims that “whether the first PDCCH is detected” refers to: whether the first PDCCH is occupied by a signal or channel other than the first signal.

In one embodiment, the statement in the claims that “whether the first PDCCH is detected” refers to: whether Blind Detection/Decoding (BD) performed on the first PDCCH is successful or not.

In one embodiment, the statement in the claims that “whether the first PDCCH is detected” refers to: whether Blind Detection/Decoding (BD) performed on a set of PDCCH candidates including at least the first PDCCH is successful or not.

In one embodiment, the statement in the claims that “whether the first PDCCH is detected” refers to: whether Blind Detection/Decoding (BD) performed jointly (or in combination) on the first PDCCH and the second PDCCH is successful or not.

In one embodiment, the statement in the claims that “whether the first PDCCH is detected” refers to: whether PDCCH decoding or DCI format decoding performed on the first PDCCH is successful (or whether it has passed CRC).

In one embodiment, the statement in the claims that “whether the first PDCCH is detected” refers to: whether PDCCH decoding or DCI format decoding performed on a set of PDCCH candidates including at least the first PDCCH is successful (or whether it has passed CRC).

In one embodiment, the statement in the claims that “whether the first PDCCH is detected” refers to: whether PDCCH decoding or DCI format decoding performed jointly (or in combination) on the first PDCCH and the second PDCCH is successful (or whether it has passed CRC).

In one embodiment, the statement in the claims that “whether the first PDCCH is detected is used to determine whether the target time-frequency resource subset comprises at least one RE occupied by the second PDCCH” includes the following meaning: whether the first PDCCH is detected is used by the first node in the present application to determine whether the target time-frequency resource subset comprises at least one RE occupied by the second PDCCH.

In one embodiment, the statement in the claims that “whether the first PDCCH is detected is used to determine whether the target time-frequency resource subset comprises at least one RE occupied by the second PDCCH” includes the following meaning: whether the first PDCCH is detected is used to determine, according to a conditional relationship, whether the target time-frequency resource subset comprises at least one RE occupied by the second PDCCH.

In one embodiment, the statement in the claims that “whether the first PDCCH is detected is used to determine whether the target time-frequency resource subset comprises at least one RE occupied by the second PDCCH” includes the following meaning: when the first PDCCH is detected, the target time-frequency resource subset comprises at least one RE occupied by the second PDCCH.

In one embodiment, the statement in the claims that “whether the first PDCCH is detected is used to determine whether the target time-frequency resource subset comprises at least one RE occupied by the second PDCCH” includes the following meaning: when the first PDCCH is detected, the target time-frequency resource subset comprises at least one RE occupied by the second PDCCH; otherwise, the target time-frequency resource subset does not comprise any RE occupied by the second PDCCH.

In one embodiment, the statement in the claims that “whether the first PDCCH is detected is used to determine whether the target time-frequency resource subset comprises at least one RE occupied by the second PDCCH” includes the following meaning: when the first PDCCH is detected or the second PDCCH is detected, the target time-frequency resource subset comprises at least one RE occupied by the second PDCCH.

In one embodiment, the statement in the claims that “whether the first PDCCH is detected is used to determine whether the target time-frequency resource subset comprises at least one RE occupied by the second PDCCH” includes the following meaning: when the first PDCCH is detected or the second PDCCH is detected, the target time-frequency resource subset comprises at least one RE occupied by the second PDCCH; otherwise, the target time-frequency resource subset does not comprise any RE occupied by the second PDCCH.

In one embodiment, the statement in the claims that “whether the first PDCCH is detected is used to determine whether the target time-frequency resource subset comprises at least one RE occupied by the second PDCCH” includes the following meaning: when the first PDCCH is detected or the second PDCCH is detected, any RE occupied by the second PDCCH is not occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected or the second PDCCH is detected, any RE occupied by the second PDCCH is not occupied by the first signal; otherwise, any RE occupied by the second PDCCH can be occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected and the second PDCCH is not dropped, or the second PDCCH is detected, any RE occupied by the second PDCCH is not occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected and the second PDCCH is not dropped, or the second PDCCH is detected, any RE occupied by the second PDCCH is not occupied by the first signal; otherwise, any RE occupied by the second PDCCH can be occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected and the second PDCCH is not dropped, any RE occupied by the second PDCCH is not occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected and the second PDCCH is being monitored, or the second PDCCH is detected, any RE occupied by the second PDCCH is not occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected and the second PDCCH is being monitored, or the second PDCCH is detected, any RE occupied by the second PDCCH is not occupied by the first signal; otherwise, any RE occupied by the second PDCCH can be occupied by the first signal.

In one embodiment, the statement in the claims that “whether the first PDCCH is detected is used to determine whether the target time-frequency resource subset comprises at least one RE occupied by the second PDCCH” includes the following meaning: when the first PDCCH is detected and the second PDCCH is being monitored, any RE occupied by the second PDCCH is not occupied by the first signal.

In one embodiment, the statement in the claims that “whether the first PDCCH is detected is used to determine whether the target time-frequency resource subset comprises at least one RE occupied by the second PDCCH” includes the following meaning: when the second PDCCH is being monitored, and at least one of the first PDCCH or the second PDCCH is detected, any RE occupied by the second PDCCH is not occupied by the first signal; otherwise, any RE occupied by the second PDCCH can be occupied by the first signal.

In one embodiment, the statement in the claims that “whether the first PDCCH is detected is used to determine whether the target time-frequency resource subset comprises at least one RE occupied by the second PDCCH” includes the following meaning: when the second PDCCH is being monitored, and at least one of the first PDCCH or the second PDCCH is detected, any RE occupied by the second PDCCH is not occupied by the first signal.

In one embodiment, the statement in the claims that “whether the first PDCCH is detected is used to determine whether the target time-frequency resource subset comprises at least one RE occupied by the second PDCCH” includes the following meaning: when the second PDCCH is not dropped, and at least one of the first PDCCH or the second PDCCH is detected, any RE occupied by the second PDCCH is not occupied by the first signal; otherwise, any RE occupied by the second PDCCH can be occupied by the first signal.

In one embodiment, the statement in the claims that “whether the first PDCCH is detected is used to determine whether the target time-frequency resource subset comprises at least one RE occupied by the second PDCCH” includes the following meaning: when the second PDCCH is not dropped, and at least one of the first PDCCH or the second PDCCH is detected, any RE occupied by the second PDCCH is not occupied by the first signal.

In one embodiment, whether the second PDCCH is detected is also used to determine whether the target time-frequency resource subset comprises at least one RE occupied by the second PDCCH.

In one embodiment, whether the second PDCCH is dropped is also used to determine whether the target time-frequency resource subset comprises at least one RE occupied by the second PDCCH.

In one embodiment, whether the second PDCCH is being monitored is also used to determine whether the target time-frequency resource subset comprises at least one RE occupied by the second PDCCH.

In one embodiment, whether the second PDCCH is counted for the number of monitorings is also used to determine whether the target time-frequency resource subset comprises at least one RE occupied by the second PDCCH.

In one embodiment, “an RE is occupied by the first signal” and “the first signal resource is mapped to an RE” are equivalent or can be used interchangeably.

In one embodiment, “an RE is not occupied by the first signal” and “the first signal resource is not mapped to an RE” are equivalent or can be used interchangeably.

In one embodiment, “the target time-frequency resource subset comprises an RE” and “an RE is not occupied (or used, or mapped) by the first signal” are equivalent or can be used interchangeably.

In one embodiment, “the target time-frequency resource subset comprises at least one RE occupied by the second PDCCH” and “none of REs occupied by the second PDCCH is occupied (or used, or mapped) by the first signal” are equivalent or can be used interchangeably.

In one embodiment, “the target time-frequency resource subset comprises at least one RE occupied by the first PDCCH” and “none of REs occupied by the first PDCCH is occupied (or used, or mapped) by the first signal” are equivalent or can be used interchangeably.

In one embodiment, “an index of the second PDCCH in the second search space set is equal to an index of the first PDCCH in the first search space set” and “the second PDCCH and the first PDCCH are linked/associated” are equivalent or can be used interchangeably.

In one embodiment, the first PDCCH and the second PDCCH can be used interchangeably.

### Embodiment 2

Embodiment 2 illustrates a schematic diagram of a network architecture according to the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management(HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR/evolved node B (gNB/eNB) 203 and other gNB(eNB) 204. The gNB(eNB)203 provides UE 201 oriented user plane and control plane terminations. The gNB(eNB)203 can be connected to other gNB(eNB) 204 via an Xn/X2 interface (like backhaul). The gNB(eNB)203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB(eNB)203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB(eNB)203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 supports multi-TRP/multi-panel PDCCH transmission.

In one embodiment, the gNB(eNB) 203 corresponds to the second node in the present application.

In one embodiment, the gNB(eNB) 203 supports multi-TRP/multi-panel PDCCH transmission.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 used for a first node (UE or gNB) and a second node (gNB or UE) is represented by three layers, which are layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block in the present application is generated by the RRC 306, or the MAC 302, or the MAC 352, or by the PHY 301, or the PHY 351.

In one embodiment, the target control signaling in the present application is generated by the RRC 306, or the MAC 302, or the MAC 352, or by the PHY 301, or the PHY 351.

In one embodiment, the first signal in the present application is generated by the RRC 306, or the MAC 302, or the MAC 352, or by the PHY 301, or the PHY 351.

In one embodiment, the second signal in the present application is generated by the PHY 301 or the PHY 351.

### Embodiment 4

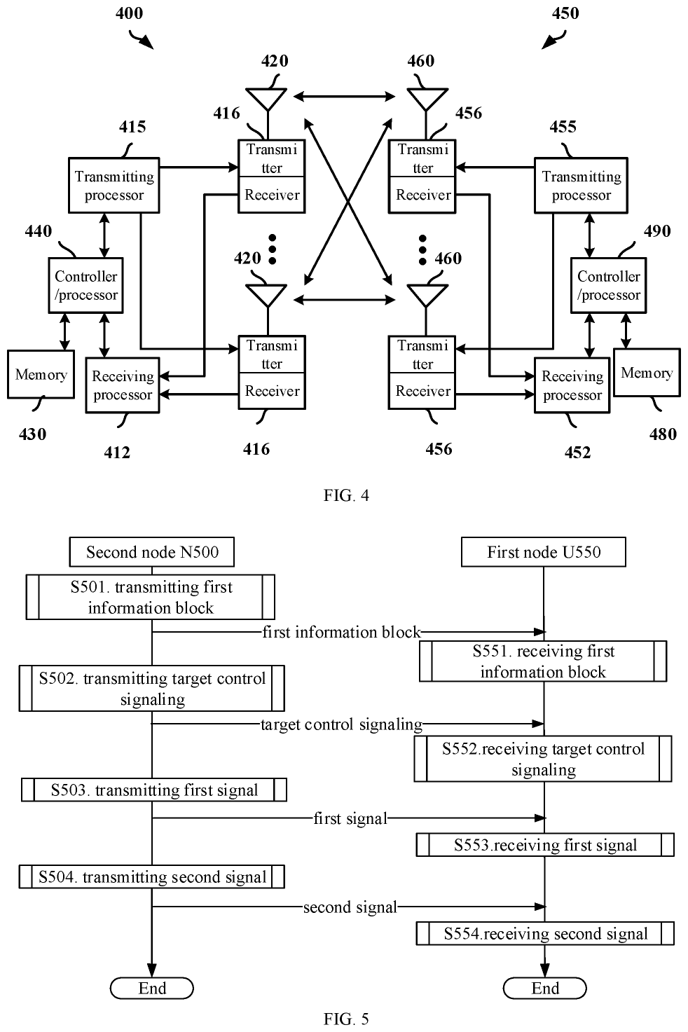

Embodiment 4 illustrates a schematic diagram of a first node and a second node according to one embodiment of the present application, as shown in FIG. 4.

The first node (450) can comprise a controller/processor 490, a data source/buffer 480, a receiving processor 452, a transmitter/receiver 456 and a transmitting processor 455, where the transmitter/receiver 456 comprises an antenna 460.

The second node (410) can comprise a controller/processor 440, a data source/buffer 430, a receiving processor 412, a transmitter/receiver 416 and a transmitting processor 415, where the transmitter/receiver 416 comprises an antenna 420.

In Downlink (DL), an upper-layer packet, for instance higher-layer information contained in the first information block in the present application and higher-layer information contained in the first signal (if the first signal includes higher-layer information) in the present application, are provided to the controller/processor 440. The controller/processor 440 provides functions of the L2 layer and above. In DL, the controller/processor 440 provides header compression, encryption, packet segmentation and reordering, multiplexing between a logical channel and a transport channel as well as radio resources allocation for the first node 450 based on various priorities. The controller/processor 440 is also responsible for HARQ operation, a retransmission of a lost packet and a signaling to the first node 450, for instance, higher-layer information in the first information block and higher-layer information in the first signal (if the first signal includes higher-layer information) in the present application are generated in the controller/processor 440. The transmitting processor 415 performs various signal processing functions used for the L1 (that is, PHY), including coding, interleaving, scrambling, modulating, power control/allocating, pre-coding and physical layer control signaling generation, for example, the generation of a physical-layer signal of the first information block and the generation of a physical-layer signal of the first signal in this application are completed in the transmitting processor 415, and the generation of the target control signaling and the generation of the second signal are completed in the transmitting processor 415. Modulation symbols that have been generated are divided into parallel streams and each of them is mapped onto a corresponding multicarrier subcarrier and/or multicarrier symbol, and then is mapped by the transmitting processor 415 to the antenna 420 via the transmitter 416 to be transmitted in the form of radio frequency signals. At the receiving end, each receiver 456 receives a radio frequency signal via a corresponding antenna 460, and recovers baseband information modulated onto a radio frequency carrier and provides the baseband information to the receiving processor 452. The receiving processor 452 performs various signal receiving processing functions used for the L1. Signal receiving processing functions include receiving a physical-layer signal of the first information block and a physical-layer signal of the first signal in this application, as well as receiving the target control signaling and the second signal in this application, and demodulating multicarrier symbols in multicarrier symbol streams based on various modulation schemes (i.e., BPSK, QPSK), then de-scrambling, decoding and de-interleaving to recover data or control signal transmitted by the second node 410 on a physical channel, and providing the data and control signal to the controller/processor 490. The controller/processor 490 is in charge of the L2 and above layers, the controller/processor 490 interprets higher-layer information contained in the first information block and the first signal in the present application (if the first signal contains higher-layer information). The controller/processor can be associated with the memory 480 that stores program code and data; the memory 480 may be called a computer readable medium.

In one embodiment, the first node 450 comprises at least one processor and at least one memory. The at least one memory comprises computer program codes; the at least one memory and the computer program codes are configured to be used in collaboration with the at least one processor. The first node 450 at least receives a first information block, the first information block used to determine a first search space set and a second search space set, the first search space set comprising at least one PDCCH candidate, and the second search space set comprising at least one PDCCH candidate, the first search space set being different from the second search space set; and receives a target control signaling and receives a first signal, the target control signaling used to determine a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, the first node 450 comprises a memory that stores a computer readable instruction program. The computer readable instruction program generates actions when executed by at least one processor. The actions include: receiving a first information block, the first information block being used to determine a first search space set and a second search space set, the first search space set comprising at least one PDCCH candidate, and the second search space set comprising at least one PDCCH candidate, the first search space set being different from the second search space set; and receiving a target control signaling and receiving a first signal, the target control signaling being used to determine a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, the second node 410 comprises at least one processor and at least one memory. The at least one memory comprises computer program codes; the at least one memory and the computer program codes are configured to be used in collaboration with the at least one processor. The second node 410 at least transmits a first information block, the first information block used to indicate a first search space set and a second search space set, the first search space set comprising at least one PDCCH candidate, and the second search space set comprising at least one PDCCH candidate, the first search space set being different from the second search space set; and transmits a target control signaling and transmits a first signal, the target control signaling used to indicate a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, the second node 410 comprises a memory that stores a computer readable instruction program. The computer readable instruction program generates actions when executed by at least one processor. The actions include: transmitting a first information block, the first information block used to indicate a first search space set and a second search space set, the first search space set comprising at least one PDCCH candidate, and the second search space set comprising at least one PDCCH candidate, the first search space set being different from the second search space set; and transmitting a target control signaling and transmitting a first signal, the target control signaling used to indicate a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, the first node 450 is a UE.

In one embodiment, the first node 450 is a UE supporting multi-TRP or multi-panel PDCCH transmission.

In one embodiment, the second node 410 is a base station (gNB/eNB).

In one embodiment, the second node 410 is a base station supporting multi-TRP or multi-panel PDCCH transmission.

In one embodiment, the receiver 456 (comprising the antenna 460), the receiving processor 452 and the controller/processor 490 are used for receiving the first information block in the present application.

In one embodiment, the receiver 456 (comprising the antenna 460), the receiving processor 452 and the controller/processor 490 are used for receiving the target control signaling in the present application.

In one embodiment, the receiver 456 (comprising the antenna 460), the receiving processor 452 and the controller/processor 490 are used for receiving the first signal in the present application.

In one embodiment, the receiver 456 (comprising the antenna 460) and the receiving processor 452 are used for receiving the first signal in the present application.

In one embodiment, the receiver 456 (comprising the antenna 460) and the receiving processor 452 are used for receiving the second signal in the present application.

In one embodiment, the transmitter 416 (comprising the antenna 420), the transmitting processor 415 and the controller/processor 440 are used for transmitting the first information block in the present application.

In one embodiment, the transmitter 416 (comprising the antenna 420), the transmitting processor 415 and the controller/processor 440 are used for transmitting the target control signaling in the present application.

In one embodiment, the transmitter 416 (comprising the antenna 420), the transmitting processor 415 and the controller/processor 440 are used for transmitting the first signal in the present application.

In one embodiment, the transmitter 416 (comprising the antenna 420) and the transmitting processor 415 are used for transmitting the first signal in the present application.

In one embodiment, the transmitter 416 (comprising the antenna 420) and the transmitting processor 415 are used for transmitting the second signal in the present application.

### Embodiment 5

Embodiment 5 illustrates a flowchart of radio signal transmission according to one embodiment of the present application, as shown in FIG. 5. In FIG. 5, a second node N500 is a maintenance base station for a serving cell for a first node U550. It should be particularly noted that the sequence illustrated herein does not set any limit to the signal transmission order or implementation order in the present application.

The second node N500 transmits a first information block in step S501, transmits a target control signaling in step S502, transmits a first signal in step S503, and transmits a second signal in step S504.

The first node U550 receives a first information block in step S551, receives a target control signaling in step S552, receives a first signal in step S553, and receives a second signal in step S554.

In Embodiment 5, the first information block is used to determine a first search space set and a second search space set, the first search space set comprising at least one PDCCH candidate, and the second search space set comprising at least one PDCCH candidate, the first search space set being different from the second search space set; the target control signaling is used to determine a first time-frequency resource set, the first time-frequency resource set comprising multiple REs, and the first signal occupying at least one RE in time-frequency domain, any RE occupied by the first signal in time-frequency domain belonging to the first time-frequency resource set; the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH; the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

In one embodiment, the target control signaling is earlier than the first signal.

In one embodiment, the target control signaling is later than the first signal.

In one embodiment, the target control signaling and the first signal are transmitted simultaneously.

In one embodiment, the second signal is earlier than the first signal.

In one embodiment, the second signal is later than the first signal.

In one embodiment, the second signal and the first signal are transmitted simultaneously.

### Embodiment 6

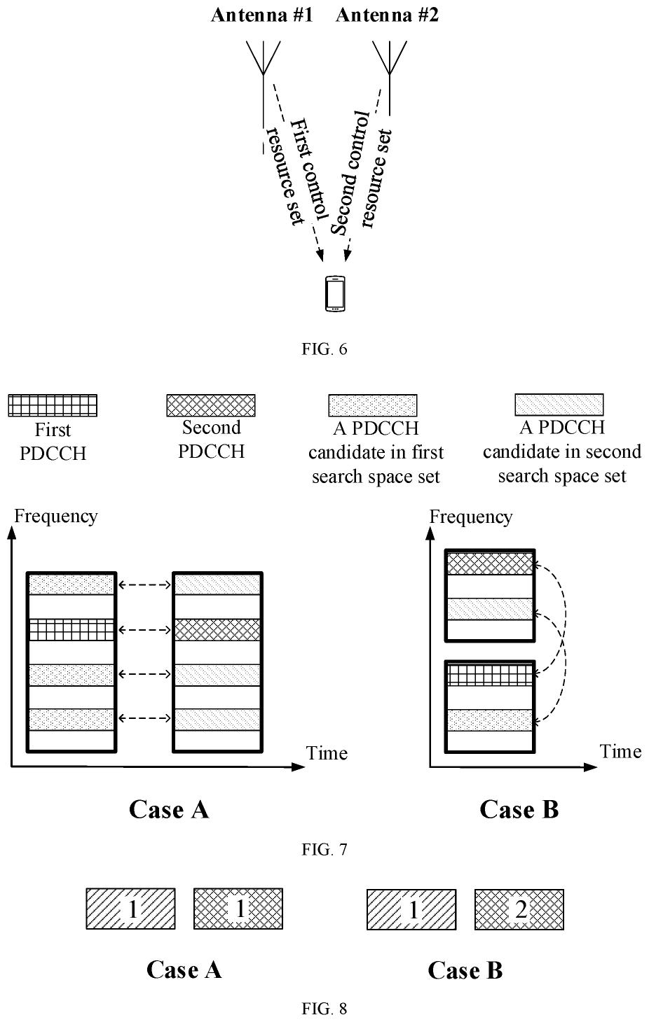

Embodiment 6 illustrates a schematic diagram of a relationship between a first control resource set and a second control resource set according to one embodiment of the present application, as shown in FIG. 6. In FIG. 6, a first control resource set and a second control resource set correspond to antenna (antenna port) #1 and antenna (antenna port) #2, respectively.

In Embodiment 6, a control resource set associated with the first search space set in the present application is a first control resource set; a control resource set associated with the second search space set in the present application is a second control resource set; quasi co-location of reference signals in the first control resource set is different from quasi co-location of reference signals in the second control resource set.

In one embodiment, the first information block in the present application is used to indicate a control resource set (CORESET) associated with the first search space set.

In one embodiment, the first information block in the present application is used to indicate a control resource set (CORESET) associated with the second search space set.

In one embodiment, an information block other than the first information block in the present application is used to indicate a control resource set (CORESET) associated with the first search space set.

In one embodiment, an information block other than the first information block in the present application is used to indicate a control resource set (CORESET) associated with the second search space set.

In one embodiment, a control resource set associated with the first search space set is a control resource set to which the PDCCH candidate(s) in the first search space set belongs/belong, and a control resource set associated with the second search space set is a control resource set to which the PDCCH candidate(s) in the second search space set belongs/belong.

In one embodiment, a control resource set associated with the first search space set is a control resource set to which CCEs occupied by the PDCCH candidate(s) in the first search space set belongs/belong, and a control resource set associated with the second search space set is a control resource set to which CCEs occupied by the PDCCH candidate(s) in the second search space set belongs/belong.

In one embodiment, a control resource set associated with the first search space set is a control resource set for which the first search space set is configured with a relationship of linkage, and a control resource set associated with the second search space set is a control resource set for which the second search space set is configured with a relationship of linkage.

In one embodiment, the first control resource set is a CORESET, and the second control resource set is a CORESET.

In one embodiment, the first control resource set and the second control resource set are different.

In one embodiment, time-frequency resources occupied by the first control resource set and time-frequency resources occupied by the second control resource set are different.

In one embodiment, time-frequency resources occupied by the first control resource set and time-frequency resources occupied by the second control resource set are the same.

In one embodiment, a number of RBs included in the first control resource set in frequency domain and a number of RBs included in the second control resource set in frequency domain are equal, a number of symbols included in the first control resource set in time domain and a number of symbols included in the second control resource set in time domain are equal, a CCE-to-REG (i.e., Resource Element Group) mapping type used by the first control resource set is the same as a CCE-to-REG mapping type used by the second control resource set, and the Precoder Granularity of the first control resource set is the same as the Precoder Granularity of the second control resource set.

In one embodiment, the first control resource set uses an Interleaved CCE to REG mapping and the second control resource set uses an Interleaved CCE to REG mapping.

In one embodiment, the first control resource set uses a Non-Interleaved CCE to REG mapping and the second control resource set uses a Non-Interleaved CCE to REG mapping.

In one embodiment, a number of rows of an interleaver of the first control resource set and a number of rows of an interleaver of the second control resource set are equal.

In one embodiment, configurations of the first control resource set and configurations of the second control resource set are the same.

In one embodiment, configurations other than Quasi Co-Location (QCL) of the first control resource set and configurations other than QCL of the second control resource set are the same.

In one embodiment, a reference signal included in the first control resource set is a Physical Downlink Control Channel (PDCCH) Demodulation Reference Signal (DMRS), and a reference signal included in the second control resource set is a PDCCH DMRS.

In one embodiment, a reference signal included in the first control resource set is a reference signal for PDCCH reception, and a reference signal included in the second control resource set is a reference signal for PDCCH reception.

In one embodiment, a reference signal included in the first control resource set is a reference signal for at least one PDCCH candidate in the first control resource set, and a reference signal included in the second control resource set is a reference signal for at least one PDCCH candidate in the second control resource set.

In one embodiment, the statement in the claims that “quasi co-location of reference signals in the first control resource set is different from quasi co-location of reference signals in the second control resource set” includes the following meaning: the reference signals in the first control resource set and the reference signals in the second control resource set are respectively Quasi Co-located with different reference signals.

In one embodiment, the statement in the claims that “quasi co-location of reference signals in the first control resource set is different from quasi co-location of reference signals in the second control resource set” includes the following meaning: the reference signals in the first control resource set and the reference signals in the second control resource set are respectively Quasi Co-located with different antenna ports.

In one embodiment, the statement in the claims that “quasi co-location of reference signals in the first control resource set is different from quasi co-location of reference signals in the second control resource set” includes the following meaning: the reference signals in the first control resource set and the reference signals in the second control resource set are respectively Quasi Co-located with reference signals occupying different time-frequency resources.

In one embodiment, the statement in the claims that “quasi co-location of reference signals in the first control resource set is different from quasi co-location of reference signals in the second control resource set” includes the following meaning: the reference signals in the first control resource set and the reference signals in the second control resource set are respectively Quasi Co-located with Synchronization Signal/Physical Broadcast Channel (SS/PBCH) Blocks with different indexes.

In one embodiment, the statement in the claims that “quasi co-location of reference signals in the first control resource set is different from quasi co-location of reference signals in the second control resource set” includes the following meaning: the reference signals in the first control resource set and the reference signals in the second control resource set are respectively Quasi Co-located with Channel Status Information Reference Signals (CSI-RS) of different antenna ports.

In one embodiment, the statement in the claims that “quasi co-location of reference signals in the first control resource set is different from quasi co-location of reference signals in the second control resource set” includes the following meaning: the reference signals in the first control resource set and the reference signals in the second control resource set are respectively Quasi Co-located with Channel Status Information Reference Signals (CSI-RS) occupying different time-frequency resources.

In one embodiment, the statement in the claims that “quasi co-location of reference signals in the first control resource set is different from quasi co-location of reference signals in the second control resource set” includes the following meaning: the first node in the present application assumes that the quasi co-location of the reference signals in the first control resource set is different from the quasi co-location of the reference signals in the second control resource set.

In one embodiment, the statement in the claims that “quasi co-location of reference signals in the first control resource set is different from quasi co-location of reference signals in the second control resource set” includes the following meaning: the first node in the present application cannot assume that the quasi co-location of the reference signals in the first control resource set and the quasi co-location of the reference signals in the second control resource set are the same.

In one embodiment, the statement in the claims that “quasi co-location of reference signals in the first control resource set is different from quasi co-location of reference signals in the second control resource set” includes the following meaning: the first node in the present application assumes that the quasi co-location of the reference signals in the first control resource set is different from the quasi co-location of the reference signals in the second control resource set.

In one embodiment, the statement in the claims that “quasi co-location of reference signals in the first control resource set is different from quasi co-location of reference signals in the second control resource set” includes the following meaning: the first node in the present application assumes that a TCI State of the reference signals in the first control resource set is different from a TCI State of the reference signals in the second control resource set.

In one embodiment, the statement in the claims that “quasi co-location of reference signals in the first control resource set is different from quasi co-location of reference signals in the second control resource set” includes the following meaning: antenna port quasi co-location of the reference signals in the first control resource set is different from antenna port quasi co-location of the reference signals in the second control resource set.

In one embodiment, the statement in the claims that “quasi co-location of reference signals in the first control resource set is different from quasi co-location of reference signals in the second control resource set” includes the following meaning: the QCL type of the reference signals in the first control resource set is different from the QCL type of the reference signals in the second control resource set.

In one embodiment, the statement in the claims that “quasi co-location of reference signals in the first control resource set is different from quasi co-location of reference signals in the second control resource set” includes the following meaning: the QCL type of the reference signals in the first control resource set is the same as the QCL type of the reference signals in the second control resource set.

In one embodiment, the first transceiver receives a second information block, where the second information block is used to determine a target quasi co-location set, the target quasi co-location set comprising more than one antenna port quasi co-location; quasi co-location of reference signals included in the first control resource set is an antenna port quasi co-location in the target quasi co-location set, and quasi co-location of reference signals in the second control resource set is an antenna port quasi co-location in the target quasi co-location set. In one subsidiary embodiment of the above embodiment, the second information block is different from the first information block. In one subsidiary embodiment of the above embodiment, the second information block is the same as the first information block. In one subsidiary embodiment of the above embodiment, the second information block and the first information block are two different IEs or fields in a same signaling.

In one embodiment, the statement in the claims that “quasi co-location of reference signals in the first control resource set is different from quasi co-location of reference signals in the second control resource set” includes the following meaning: an index value of a control resource set resource pool (CORESET Pool) to which the first control resource set belongs and an index value of a control resource set resource pool (CORESET Pool) to which the second control resource set belongs are unequal.

In one embodiment, an index value of a control resource set resource pool (CORESET Pool) to which the first control resource set belongs and an index value of a control resource set resource pool (CORESET Pool) to which the second control resource set belongs are unequal.

In one embodiment, an index value of a control resource set resource pool (CORESET Pool) to which the first control resource set belongs and an index value of a control resource set resource pool (CORESET Pool) to which the second control resource set belongs are equal.

### Embodiment 7

Embodiment 7 illustrates a schematic diagram of a relationship between a first PDCCH and a second

PDCCH according to one embodiment of the present application, as shown in FIG. 7. In FIG. 7, in Case A and Case B, the horizontal axis represents time, the vertical axis represents frequency, each boldly-framed rectangular box represents a control resource set associated with a search space set, the reticle-filled rectangle represents a first PDCCH, the cross-filled rectangle represents a second PDCCH, each dot-filled rectangle represents a PDCCH candidate with the same aggregation level as the first PDCCH that is included in the first search space set, each slash-filled rectangle represents a PDCCH candidate with the same aggregation level as the second PDCCH that is included in the second search space set, and the dotted lines with arrow indicates the relationship of mutual linkage. In case A, the first PDCCH and the second PDCCH are time-division multiplexing (TDM); in case B, the first PDCCH and the second PDCCH are frequency-division multiplexing (FDM).

In Embodiment 7, an aggregation level of the first PDCCH in this application is equal to an aggregation level of the second PDCCH in this application, and an index of the first PDCCH in the first search space set in this application is equal to an index of the second PDCCH in the second search space set in this application, and a control signaling carried by the second PDCCH is the same as a control signaling carried by the first PDCCH; whether the first PDCCH is detected is used to determine whether the target time-frequency resource subset in this application comprises at least one RE occupied by the first PDCCH.

In one embodiment, an Aggregation Level (AL) of the first PDCCH is equal to the number of CCEs included in the first PDCCH, and an Aggregation Level (AL) of the second PDCCH is equal to the number of CCEs included in the second PDCCH.

In one embodiment, an Aggregation Level (AL) of the first PDCCH is equal to one of 1, 2, 4, 8, or 16, and an Aggregation Level (AL) of the second PDCCH is equal to one of 1, 2, 4, 8, or 16.

In one embodiment, an Aggregation Level (AL) of the first PDCCH is a positive integer, and an Aggregation Level (AL) of the second PDCCH is a positive integer.

In one embodiment, an index of the first PDCCH in the first search space set is a non-negative integer, and an index of the second PDCCH in the second search space set is a non-negative integer.

In one embodiment, the PDCCH candidate(s) in the first search space set is(are sequentially) indexed, and an index of the first PDCCH in the first search space set is an index value of a PDCCH candidate corresponding to the first PDCCH; the PDCCH candidate(s) in the second search space set is(are sequentially) indexed, and an index of the second PDCCH in the second search space set is an index value of a PDCCH candidate corresponding to the second PDCCH.

In one embodiment, the PDCCH candidate(s) in the first search space set is(are sequentially) indexed according to pre-defined rules, and an index of the first PDCCH in the first search space set is an index value of a PDCCH candidate corresponding to the first PDCCH; the PDCCH candidate(s) in the second search space set is(are sequentially) indexed according to pre-defined rules, and an index of the second PDCCH in the second search space set is an index value of a PDCCH candidate corresponding to the second PDCCH.

In one embodiment, an aggregation level of the first PDCCH and an aggregation level of the second PDCCH are both equal to a target aggregation level, an index of the first PDCCH in the first search space set is an index of the first PDCCH among PDCCH candidates in the first search space set that employ the target aggregation level, and an index of the second PDCCH in the second search space set is an index of the second PDCCH among PDCCH candidates in the second search space set that employ the target aggregation level.

In one embodiment, the PDCCH candidate(s) in the first search space set is(are sequentially) indexed according to a starting CCE being occupied, and an index of the first PDCCH in the first search space set is an index value of a PDCCH candidate corresponding to the first PDCCH; the PDCCH candidate(s) in the second search space set is(are sequentially) indexed according to a starting CCE being occupied, and an index of the second PDCCH in the second search space set is an index value of a PDCCH candidate corresponding to the second PDCCH.

In one embodiment, an index of the first PDCCH in the first search space set is a value of m_{s,n}_{_{Cl}} of the first PDCCH, and an index of the second PDCCH in the second search space set is a value of m_{s,n}_{_{Cl}} of the second PDCCH.

In one embodiment, a control signaling carried by the second PDCCH is a DCI format, and a control signaling carried by the first PDCCH is a DCI format.

In one embodiment, a control signaling carried by the second PDCCH comprises all or part of fields in a DCI format, and a control signaling carried by the first PDCCH comprises all or part of fields in a DCI format.

In one embodiment, a control signaling carried by the second PDCCH comprises a DCI payload employing a DCI format, and a control signaling carried by the first PDCCH comprises a DCI payload employing a DCI format.

In one embodiment, a control signaling carried by the second PDCCH is a DCI format employed in monitoring the second PDCCH, and a control signaling carried by the first PDCCH is a DCI format employed in monitoring the first PDCCH.

In one embodiment, corresponding fields comprised in a control signaling carried by the second PDCCH and a control signaling carried by the first PDCCH are of equal values.

In one embodiment, corresponding parameters comprised in a control signaling carried by the second PDCCH and a control signaling carried by the first PDCCH are of equal values.

In one embodiment, a control signaling carried by the second PDCCH and a control signaling carried by the first PDCCH are repetitions of a DCI format.

In one embodiment, the first node in the present application assumes that a control signaling carried by the second PDCCH is the same as that carried by the first PDCCH.

In one embodiment, the statement in the claims that “whether the first PDCCH is detected is used to determine whether the target time-frequency resource subset comprises at least one RE occupied by the first PDCCH” includes the following meaning: whether the first PDCCH is detected is used by the first node in the present application to determine whether the target time-frequency resource subset comprises at least one RE occupied by the first PDCCH.

In one embodiment, the statement in the claims that “whether the first PDCCH is detected is used to determine whether the target time-frequency resource subset comprises at least one RE occupied by the first PDCCH” includes the following meaning: whether the first PDCCH is detected is used to determine, according to a conditional relationship, whether the target time-frequency resource subset comprises at least one RE occupied by the first PDCCH.

In one embodiment, the statement in the claims that “whether the first PDCCH is detected is used to determine whether the target time-frequency resource subset comprises at least one RE occupied by the first PDCCH” includes the following meaning: when the first PDCCH is detected, the target time-frequency resource subset comprises at least one RE occupied by the first PDCCH.

In one embodiment, the statement in the claims that “whether the first PDCCH is detected is used to determine whether the target time-frequency resource subset comprises at least one RE occupied by the first PDCCH” includes the following meaning: when the first PDCCH is detected, the target time-frequency resource subset comprises at least one RE occupied by the first PDCCH; otherwise, the target time-frequency resource subset does not comprise any RE occupied by the first PDCCH.

In one embodiment, the statement in the claims that “whether the first PDCCH is detected is used to determine whether the target time-frequency resource subset comprises at least one RE occupied by the first PDCCH” includes the following meaning: when the first PDCCH is detected or the second PDCCH is detected, the target time-frequency resource subset comprises at least one RE occupied by the first PDCCH.

In one embodiment, the statement in the claims that “whether the first PDCCH is detected is used to determine whether the target time-frequency resource subset comprises at least one RE occupied by the first PDCCH” includes the following meaning: when the first PDCCH is detected or the second PDCCH is detected, the target time-frequency resource subset comprises at least one RE occupied by the first PDCCH; otherwise, the target time-frequency resource subset does not comprise any RE occupied by the first PDCCH.

In one embodiment, the statement in the claims that “whether the first PDCCH is detected is used to determine whether the target time-frequency resource subset comprises at least one RE occupied by the first PDCCH” includes the following meaning: when the first PDCCH is detected or the second PDCCH is detected, any RE occupied by the first PDCCH is not occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is detected or the second PDCCH is detected, any RE occupied by the first PDCCH is not occupied by the first signal; otherwise, any RE occupied by the first PDCCH can be occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is not dropped, and at least one of the first PDCCH or the second PDCCH is detected, any RE occupied by the first PDCCH is not occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is not dropped, and at least one of the first PDCCH or the second PDCCH is detected, any RE occupied by the first PDCCH is not occupied by the first signal; otherwise, any RE occupied by the first PDCCH can be occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is not dropped and the second PDCCH is detected, any RE occupied by the first PDCCH is not occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is being monitored and the second PDCCH is detected, any RE occupied by the first PDCCH is not occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is being monitored, and at least one of the first PDCCH or the second PDCCH is detected, any RE occupied by the first PDCCH is not occupied by the first signal; otherwise, any RE occupied by the first PDCCH can be occupied by the first signal.

In one embodiment, the statement in the claims that “whether the first PDCCH is detected is used to determine whether the target time-frequency resource subset comprises at least one RE occupied by the first PDCCH” includes the following meaning: when the first PDCCH is being monitored and the second PDCCH is detected, any RE occupied by the first PDCCH is not occupied by the first signal.

In one embodiment, whether the second PDCCH is detected is also used to determine whether the target time-frequency resource subset comprises at least one RE occupied by the first PDCCH.

In one embodiment, whether the first PDCCH is dropped is also used to determine whether the target time-frequency resource subset comprises at least one RE occupied by the first PDCCH.

In one embodiment, whether the first PDCCH is being monitored is also used to determine whether the target time-frequency resource subset comprises at least one RE occupied by the first PDCCH.

In one embodiment, whether the first PDCCH is counted for the number of monitorings is also used to determine whether the target time-frequency resource subset comprises at least one RE occupied by the first PDCCH.

### Embodiment 8

Embodiment 8 illustrates a schematic diagram of a target value according to one embodiment of the present application, as shown in FIG. 8. In FIG. 8, 2 candidate target values and their corresponding distributions on a first PDCCH and a second PDCCH are given, in each case, the slash-filled rectangle represents the second PDCCH, the cross-filled rectangle represents the first PDCCH, and the number in each rectangular box represents the number of monitorings distributed on the corresponding PDCCH candidate for the target values.

In Embodiment 8, a target value is equal to a total number of monitorings performed on the first PDCCH in this application and the second PDCCH in this application, the target value being a positive integer; at least one of whether the second PDCCH is being monitored or the target value is used to determine whether the target time-frequency resource subset in this application comprises at least one RE occupied by the second PDCCH.

In one embodiment, the target value is equal to one of 2 or 3.

In one embodiment, the target value can be greater than 3.

In one embodiment, the first information block is used to indicate the target value.

In one embodiment, an information block other than the first information block is used to indicate the target value.

In one embodiment, the target value is equal to a budget value for a total number of blind detections assigned on the first PDCCH and the second PDCCH.

In one embodiment, the target value is equal to a total number of channel decodings performed on the first PDCCH and the second PDCCH.

In one embodiment, the target value is equal to a total number of channel decodings performed on the first PDCCH and the second PDCCH for a DCI format.

In one embodiment, the target value is equal to a total number of channel decodings performed on the first PDCCH and the second PDCCH for a DCI Payload Size.

In one embodiment, the target value is equal to a total number of monitorings performed on the first PDCCH and the second PDCCH as configured by the second node in the present application.

In one embodiment, a total number of monitorings actually performed on the first PDCCH and the second PDCCH is related to the implementation of the first node in this application.

In one embodiment, the target value is equal to a number of monitorings that have been counted in total on the first PDCCH and the second PDCCH.

In one embodiment, the target value is equal to a number of monitorings that have been counted in total on the first PDCCH and the second PDCCH for overbooking.

In one embodiment, the statement in the claims that “at least one of whether the second PDCCH is being monitored or the target value is used to determine whether the target time-frequency resource subset comprises at least one RE occupied by the second PDCCH” includes the following meaning: at least one of whether the second PDCCH is being monitored or the target value is used by the first node or the second node in the present application to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: whether the second PDCCH is being monitored and the target value are both used to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: whether the second PDCCH is being monitored is used to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: the target value is used to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: at least one of whether the second PDCCH is dropped or the target value is used to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the second PDCCH is being monitored, whether the first PDCCH is detected is used to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the second PDCCH is being monitored, whether the first PDCCH is detected is used to determine whether the target time-frequency resource subset comprises at least one RE occupied by the second PDCCH; otherwise, the target time-frequency resource subset does not comprise at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the second PDCCH is being monitored, whether at least one of the second PDCCH or the first PDCCH is detected is used to determine whether the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the second PDCCH is being monitored, whether at least one of the second PDCCH or the first PDCCH is detected is used to determine whether the target time-frequency resource subset comprises at least one RE occupied by the second PDCCH; otherwise, the target time-frequency resource subset does not comprise at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the second PDCCH is being monitored and at least one of the second PDCCH or the first PDCCH is detected, the target time-frequency resource subset comprises at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the second PDCCH is being monitored and at least one of the second PDCCH or the first PDCCH is detected, the target time-frequency resource subset comprises at least one RE occupied by the second PDCCH; otherwise, the target time-frequency resource subset does not comprise at least one RE occupied by the second PDCCH.

In one embodiment, the statement in the claims that “at least one of whether the second PDCCH is being monitored or the target value is used to determine whether the target time-frequency resource subset comprises at least one RE occupied by the second PDCCH” includes the following meaning: when the target value is equal to a given value, whether at least one of the second PDCCH or the first PDCCH is detected is used to determine whether the target time-frequency resource subset comprises at least one RE occupied by the second PDCCH; otherwise, the target time-frequency resource subset does not comprise at least one RE occupied by the second PDCCH; the given value is a positive integer that is pre-defined or fixed.

In one embodiment, the statement in the claims that “at least one of whether the second PDCCH is being monitored or the target value is used to determine whether the target time-frequency resource subset comprises at least one RE occupied by the second PDCCH” includes the following meaning: when the target value is equal to a given value, whether at least one of the second PDCCH or the first PDCCH is detected is used to determine whether the target time-frequency resource subset comprises at least one RE occupied by the second PDCCH; otherwise, whether the second PDCCH is detected is used to determine whether the target time-frequency resource subset comprises at least one RE occupied by the second PDCCH; the given value is a positive integer that is pre-defined or fixed.

In one embodiment, the statement in the claims that “at least one of whether the second PDCCH is being monitored or the target value is used to determine whether the target time-frequency resource subset comprises at least one RE occupied by the second PDCCH” includes the following meaning: when the target value is equal to a given value, whether at least one of the second PDCCH or the first PDCCH is detected is used to determine whether the target time-frequency resource subset comprises at least one RE occupied by the second PDCCH; the given value is a positive integer that is pre-defined or fixed.

In one embodiment, the statement in the claims that “at least one of whether the second PDCCH is being monitored or the target value is used to determine whether the target time-frequency resource subset comprises at least one RE occupied by the second PDCCH” includes the following meaning: when the target value is equal to a given value and the second PDCCH is being monitored, whether at least one of the second PDCCH or the first PDCCH is detected is used to determine whether the target time-frequency resource subset comprises at least one RE occupied by the second PDCCH; otherwise, the target time-frequency resource subset does not comprise at least one RE occupied by the second PDCCH; the given value is a positive integer that is pre-defined or fixed.

In one embodiment, the statement in the claims that “at least one of whether the second PDCCH is being monitored or the target value is used to determine whether the target time-frequency resource subset comprises at least one RE occupied by the second PDCCH” includes the following meaning: when the target value is equal to a given value and the second PDCCH is being monitored, whether at least one of the second PDCCH or the first PDCCH is detected is used to determine whether the target time-frequency resource subset comprises at least one RE occupied by the second PDCCH; the given value is a positive integer that is pre-defined or fixed.

In one embodiment, whether there is at least one overlapping RE between REs occupied by the second PDCCH and a characteristic time-frequency resource set is used to determine whether the second PDCCH is being monitored, the characteristic time-frequency resource set comprising at least one RE, the characteristic time-frequency resource set being pre-defined or signaling-configured. In one subsidiary embodiment of the above embodiment, the characteristic time-frequency resource set comprises REs occupied by a Synchronization Signal/Physical Broadcast Channel (SS/PBCH) Block. In one subsidiary embodiment of the above embodiment, the characteristic time-frequency resource set comprises REs occupied by a Common Reference Signal (CRS) of LTE. In one subsidiary embodiment of the above embodiment, “whether the second PDCCH is being monitored” and “whether there is an overlap between REs occupied by the second PDCCH and the characteristic time-frequency resource set” are equivalent or can be used interchangeably. In one subsidiary embodiment of the above embodiment, the characteristic time-frequency resource set is configured by “lte-CRS-ToMatchAround” or “LTE-CRS-PatternList-r16” or “RateMatchPattern” or “availableRB-SetPerCell-r16” signaling. In one subsidiary embodiment of the above embodiment, the characteristic time-frequency resource set comprises REs occupied by a Physical Random Access Channel (PRACH). In one subsidiary embodiment of the above embodiment, the characteristic time-frequency resource set comprises REs configured to be used on uplink symbols. In one subsidiary embodiment of the above embodiment, the characteristic time-frequency resource set comprises REs indicated by DCI format 2_1 as being on reserved RBs or reserved time-domain symbols. In one subsidiary embodiment of the above embodiment, the characteristic time-frequency resource set comprises resources of a CORESET being dropped for monitoring due to a QCL type-D conflict.

In one embodiment, “whether the second PDCCH is being monitored” and “whether the second PDCCH is dropped” are equivalent or can be used interchangeably.

In one embodiment, “the second PDCCH is being monitored” and “the second PDCCH is not dropped” are equivalent or can be used interchangeably.

In one embodiment, “the second PDCCH is not being monitored” and “the second PDCCH is dropped” are equivalent or can be used interchangeably.

In one embodiment, “whether the second PDCCH is being monitored” and “whether there is at least one PDCCH decoding or blind detection performed in a set of PDCCH candidates including the second PDCCH” are equivalent or can be used interchangeably.

In one embodiment, “whether the second PDCCH is being monitored” and “whether the second PDCCH is counted for the number of monitorings or for the number of blind detections” are equivalent or can be used interchangeably.

### Embodiment 9

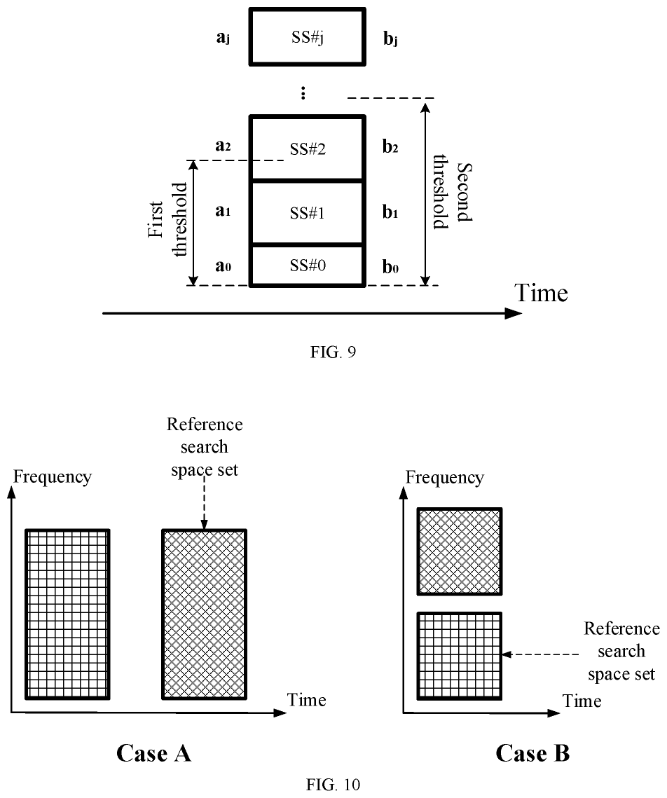

Embodiment 9 illustrates a schematic diagram of relationships between a second PDCCH and a first threshold and a second threshold according to one embodiment of the present application, as shown in FIG. 9. In FIG. 9, the horizontal axis represents time, each thick-line framed rectangle represents a search space set, a₀, a₁, a₂, . . . , aⱼ represent the numbers of PDCCH monitorings in corresponding search space sets, respectively; b₀, b₁, b₂, . . . , bⱼ represent the numbers of non-overlapped CCEs occupied by monitored PDCCH candidates in corresponding search space sets, respectively; where b₀+b₁≤second threshold and a₀+a₁≤first threshold, and a₀+a₁+a₂≥first threshold or b₀+b₁+b₂≥second threshold.

In Embodiment 9, at least one symbol occupied by the second PDCCH in this application in time domain belongs to a first time window, and a subcarrier occupied by the second PDCCH in frequency domain belongs to a first BWP; a first threshold is equal to a maximum number of PDCCH monitorings performed by a receiver of the target control signaling in this application within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold in this application are used together to determine whether the second PDCCH is being monitored.

In one embodiment, the first time window is a slot.

In one embodiment, the first time window is a subframe.

In one embodiment, the first time window is a Span.

In one embodiment, the first time window is a time window for a subcarrier spacing (SCS).

In one embodiment, the first time window comprises at least one symbol that is contiguous in time domain.

In one embodiment, any symbol occupied by the second PDCCH in time domain belongs to the first time window.

In one embodiment, one symbol occupied by the second PDCCH in time domain belongs outside the first time window.

In one embodiment, any symbol occupied by the second PDCCH in time domain is an OFDM symbol.

In one embodiment, any symbol occupied by the second PDCCH in time domain is an OFDM symbol for a subcarrier spacing (SCS).

In one embodiment, any symbol occupied by the second PDCCH in time domain comprises a cyclic prefix and a data part.

In one embodiment, the second PDCCH occupies at least one symbol in time domain.

In one embodiment, the second PDCCH occupies at least one subcarrier in frequency domain.

In one embodiment, any subcarrier occupied by the second PDCCH in frequency domain belongs to the first Bandwidth Part (BWP).

In one embodiment, one subcarrier occupied by the second PDCCH in frequency domain belongs outside the first BWP.

In one embodiment, the first information block is used to configure the first BWP.

In one embodiment, an information block other than the first information block is used to configure the first BWP.

In one embodiment, the first BWP is an Active BWP.

In one embodiment, the first BWP is a Default BWP.

In one embodiment, the first BWP is an Initial BWP.

In one embodiment, the first threshold is greater than 1.

In one embodiment, the first threshold can be equal to 1.

In one embodiment, the first threshold is pre-defined or configured by signaling.

In one embodiment, the first threshold is related to the first node's capability.

In one embodiment, a capability report of the first node is used to indicate, either explicitly or implicitly, the first threshold.

In one embodiment, the first threshold is related to a subcarrier spacing (SCS) of the first BWP.

In one embodiment, the first threshold is related to a number of serving cells the first node is configured with.

In one embodiment, the first threshold is related to a number of time-domain symbols included in the first time window.

In one embodiment, a number of PDCCH monitorings performed by a receiver of the target control signaling within the first time window and on the first BWP is not greater than the first threshold.

In one embodiment, a receiver of the target control signaling expects that a number of PDCCH monitorings performed within the first time window and on the first BWP is not greater than the first threshold.

In one embodiment, a receiver of the target control signaling does not expect that a number of PDCCH monitorings performed within the first time window and on the first BWP is greater than the first threshold.

In one embodiment, a number of PDCCH monitorings for a serving cell performed by a receiver of the target control signaling within the first time window and on the first BWP is not greater than the first threshold.

In one embodiment, a number of PDCCH monitorings for a serving cell group performed by a receiver of the target control signaling within the first time window and on the first BWP is not greater than the first threshold.

In one embodiment, a number of PDCCH monitorings for a scheduled serving cell performed by a receiver of the target control signaling within the first time window and on the first BWP is not greater than the first threshold.

In one embodiment, a number of PDCCH monitorings for a scheduled serving cell group performed by a receiver of the target control signaling within the first time window and on the first BWP is not greater than the first threshold.

In one embodiment, a number of PDCCH monitorings performed by a receiver of the target control signaling within the first time window and on a serving cell to which the first BWP belongs is not greater than the first threshold.

In one embodiment, the first threshold is equal to M_{PDCCH}^{max,slot,μ}, or the first threshold is equal to M_{PDCCH}^{max,(X,Y),μ}, or the first threshold is equal to M_{PDCCH}^{total,slot,μ}, or the first threshold is equal to M_{PDCCH}^{total,(X,Y),μ}.

In one embodiment, the first threshold is equal to a smaller value between M_{PDCCH}^{max,slot,μ} and M_{PDCCH}^{total,slot,μ}.

In one embodiment, the first threshold is equal to a smaller value between M_{PDCCH}^{max,(X,Y),μ} and M_{PDCCH}^{total,(X,Y),μ}.

In one embodiment, the first threshold is equal to M_{PDCCH}^{uss}.

In one embodiment, the second threshold is greater than 1.

In one embodiment, the second threshold can be equal to 1.

In one embodiment, the second threshold is pre-defined or configured by signaling.

In one embodiment, the second threshold is related to the first node's capability.

In one embodiment, a capability report of the first node is used to indicate, either explicitly or implicitly, the second threshold.

In one embodiment, the second threshold is related to a subcarrier spacing (SCS) of the first BWP.

In one embodiment, the second threshold is related to a number of serving cells the first node is configured with.

In one embodiment, the second threshold is related to a number of time-domain symbols included in the first time window.

In one embodiment, a number of Non-Overlapped CCEs occupied by PDCCH candidates monitored by a receiver of the target control signaling within the first time window and on the first BWP is not greater than the second threshold.

In one embodiment, a receiver of the target control signaling expects that a number of Non-Overlapped CCEs occupied by PDCCH candidates monitored within the first time window and on the first BWP is not greater than the second threshold.

In one embodiment, a receiver of the target control signaling does not expect that a number of Non-Overlapped CCEs occupied by PDCCH candidates monitored within the first time window and on the first BWP is greater than the second threshold.

In one embodiment, a number of Non-Overlapped CCEs occupied by PDCCH candidates monitored by a receiver of the target control signaling for a serving cell within the first time window and on the first BWP is not greater than the second threshold.

In one embodiment, a number of Non-Overlapped CCEs occupied by PDCCH candidates monitored by a receiver of the target control signaling for a serving cell group within the first time window and on the first BWP is not greater than the second threshold.

In one embodiment, a number of Non-Overlapped CCEs occupied by PDCCH candidates monitored by a receiver of the target control signaling for a scheduled serving cell within the first time window and on the first BWP is not greater than the second threshold.

In one embodiment, a number of Non-Overlapped CCEs occupied by PDCCH candidates monitored by a receiver of the target control signaling for a scheduled serving cell group within the first time window and on the first BWP is not greater than the second threshold.

In one embodiment, a number of Non-Overlapped CCEs occupied by PDCCH candidates monitored by a receiver of the target control signaling within the first time window and on a serving cell to which the first BWP belongs is not greater than the second threshold.

In one embodiment, the second threshold is equal to C_{PDCCH}^{max,slot,μ}, or the second threshold is equal to C_{PDCCH}^{max,(X,Y),μ}, or the second threshold is equal to C_{PDCCH}^{total,slot,μ}, or the second threshold is equal to C_{PDCCH}^{total,(X,Y),μ}.

In one embodiment, the second threshold is equal to a smaller value between C_{PDCCH}^{max,slot,μ} and C_{PDCCH}^{total,slot,μ}.

In one embodiment, the second threshold is equal to a smaller value between C_{PDCCH}^{max,slot,μ} and C_{PDCCH}^{total,(X,Y),μ}.

In one embodiment, the second threshold is equal to C_{PDCCH}^{uss}.

In one embodiment, the statement in the claims that “the second search space set, the first threshold and the second threshold are used together to determine whether the second PDCCH is being monitored” includes the following meaning: the second search space set, the first threshold and the second threshold are used together by the first node or the second node in the present application to determine whether the second PDCCH is being monitored.

In one embodiment, the statement in the claims that “the second search space set, the first threshold and the second threshold are used together to determine whether the second PDCCH is being monitored” includes the following meaning: the second search space set, the first threshold and the second threshold are used together to determine whether the second PDCCH is dropped in overbooking.

In one embodiment, the statement in the claims that “the second search space set, the first threshold and the second threshold are used together to determine whether the second PDCCH is being monitored” includes the following meaning: an index or ID of the second search space set, the first threshold and the second threshold are used together to determine whether the second PDCCH is being monitored.

In one embodiment, the statement in the claims that “the second search space set, the first threshold and the second threshold are used together to determine whether the second PDCCH is being monitored” includes the following meaning: ordering of an index or ID of the second search space set, the first threshold and the second threshold are used together to determine whether the PDCCH candidate(s) in the second search space set is(are) being monitored.

In one embodiment, the statement in the claims that “the second search space set, the first threshold and the second threshold are used together to determine whether the second PDCCH is being monitored” includes the following meaning: an index or ID of the second search space set, the first threshold and the second threshold are used together to determine whether the second search space set is being monitored or dropped.

In one embodiment, the statement in the claims that “the second search space set, the first threshold and the second threshold are used together to determine whether the second PDCCH is being monitored” includes the following meaning: the order or arrangement of an index or ID of the second search space set among multiple search space sets, the first threshold and the second threshold are used together to determine whether the second search space set is being monitored or dropped.

In one embodiment, the statement in the claims that “the second search space set, the first threshold and the second threshold are used together to determine whether the second PDCCH is being monitored” includes the following meaning: the order of an index or ID of the second search space set among multiple search space sets, the number of PDCCH candidate(s) included in the second search space set, the first threshold and the second threshold are used together to determine whether the second search space set is being monitored or dropped based on pre-defined pseudo codes.

In one embodiment, the statement in the claims that “the second search space set, the first threshold and the second threshold are used together to determine whether the second PDCCH is being monitored” includes the following meaning: the second search space set is one of multiple sequentially indexed or arranged search space sets, the multiple sequentially indexed or arranged search space sets are sequentially joined in a monitored group of search space sets in order of indexing or arranging; the monitored group of search space sets includes a maximum number of search space sets in instances when the number of PDCCH candidate(s) counted for the number of monitorings is no greater than the first threshold and the number of Non-overlapped CCEs occupied by the PDCCH candidate(s) counted for the number of monitorings is no greater than the second threshold; whether the monitored group of search space sets includes the second search space set is used to determine whether the second PDCCH is being monitored.

In one embodiment, the statement in the claims that “the second search space set, the first threshold and the second threshold are used together to determine whether the second PDCCH is being monitored” includes the following meaning: the second search space set is one of multiple sequentially indexed or arranged search space sets, the multiple sequentially indexed or arranged search space sets are sequentially joined in a monitored group of search space sets in order of indexing or arranging; the monitored group of search space sets includes a maximum number of search space sets in instances when the number of PDCCH candidate(s) counted for the number of monitorings is no greater than the first threshold and the number of Non-overlapped CCEs occupied by the PDCCH candidate(s) counted for the number of monitorings is no greater than the second threshold; when the monitored group of search space sets includes the second search space set, each PDCCH candidate included in the second search space set is being monitored; otherwise, any PDCCH candidate included in the second search space set is not being monitored.

### Embodiment 10

Embodiment 10 illustrates a schematic diagram of a reference search space set according to one embodiment of the present application, as shown in FIG. 10. In Case A and Case B of FIG. 10, the horizontal axis represents time, the vertical axis represents frequency, the reticle-filled rectangle represents a first search space set, the cross-filled rectangle represents a second search space set, and the dashed line with an arrow indicates a reference search space set. In Case A, the PDCCH candidate(s) included in the first search space set and the PDCCH candidate(s) included in the second search space set are time division multiplexing (TDM); in Case B, the PDCCH candidate(s) included in the first search space set and the PDCCH candidate(s) included in the second search space set are frequency division multiplexing (FDM).

In Embodiment 10, the first information block in this application is used to indicate a reference search space set, the reference search space set being one of the first search space set in this application or the second search space set in this application; whether the reference search space set and the second search space set are the same is used to determine whether the target time-frequency resource subset in this application comprises at least one RE occupied by the second PDCCH in which application.

In one embodiment, the statement in the claims that “the first information block is used to indicate a reference search space set” includes the following meaning: the first information block is used by the second node in the present application to indicate the reference search space set.

In one embodiment, the statement in the claims that “the first information block is used to indicate a reference search space set” includes the following meaning: the first information block is used to explicitly or implicitly indicate the reference search space set.

In one embodiment, the statement in the claims that “the first information block is used to indicate a reference search space set” includes the following meaning: one or more fields in the first information block is/are used to explicitly or implicitly indicate the reference search space set.

In one embodiment, the statement in the claims that “the first information block is used to indicate a reference search space set” includes the following meaning: one or more IEs in the first information block is/are used to explicitly or implicitly indicate the reference search space set.

In one embodiment, the statement in the claims that “the first information block is used to indicate a reference search space set” includes the following meaning: the first information block is used to explicitly or implicitly indicate an index value or ID of the reference search space set.

In one embodiment, the statement in the claims that “the first information block is used to indicate a reference search space set” includes the following meaning: the first information block is used to explicitly or implicitly indicate the reference search space set from the first search space set or the second search space set.

In one embodiment, the statement in the claims that “the first information block is used to indicate a reference search space set” includes the following meaning: the first information block comprises at least one of a first field or a second field, the first field being used to indicate whether the first search space set is the reference search space set, while the second field being used to indicate whether the second search space set is the reference search space set. In one subsidiary embodiment of the above embodiment, both the first field and the second field are used to indicate a Boolean value (BOOLEAN). In one subsidiary embodiment of the above embodiment, whether the first field exists in the first information block is used to indicate whether the first search space set is the reference search space set, and whether the second field exists in the first information block is used to indicate whether the second search space set is the reference search space set. In one subsidiary embodiment of the above embodiment, a field or IE “searchSpaceLinking” included in the first information block comprises at least one of the first field or the second field.

In one embodiment, the statement in the claims that “the first information block is used to indicate a reference search space set” includes the following meaning: at least one field in an IE“searchSpaceLinking” in the first information block is used to explicitly or implicitly indicate the reference search space set from the first search space set or the second search space set.

In one embodiment, an index value of the first search space set is a non-negative integer.

In one embodiment, an index value of the first search space set is equal to one of 0, 1, 2 . . . and 39.

In one embodiment, an index value of the first search space set is equal to a non-negative integer no greater than 39.

In one embodiment, an index value of the second search space set is a non-negative integer.

In one embodiment, an index value of the second search space set is equal to one of 0, 1, 2 . . . and 39.

In one embodiment, an index value of the second search space set is equal to a non-negative integer no greater than 39.

In one embodiment, an index value of the reference search space set is equal to one of an index value of the first search space set or an index value of the second search space set.

In one embodiment, “an index value of a search space set” and “an ID of a search space set” are equivalent or interchangeable.

In one embodiment, “an index value of the first search space set” and “an ID of the first search space set” are equivalent or interchangeable.

In one embodiment, “an index value of the second search space set” and “an ID of the second search space set” are equivalent or interchangeable.

In one embodiment, the statement in the claims that “whether the reference search space set and the second search space set are the same is used to determine whether the target time-frequency resource subset comprises at least one RE occupied by the second PDCCH” includes the following meaning: whether the reference search space set and the second search space set are the same is used by the first node or the second node in the present application to determine whether the target time-frequency resource subset comprises at least one RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: whether an index value of the reference search space set and an index value of the second search space set are the same is used to determine whether the target time-frequency resource subset comprises at least one RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: when the reference search space set and the second search space set are the same, whether at least one of the first PDCCH or the second PDCCH is detected is used to determine whether the target time-frequency resource subset comprises at least one RE occupied by the second PDCCH; otherwise, the target time-frequency resource subset does not comprise any RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: when the reference search space set and the second search space set are the same, whether at least one of the first PDCCH or the second PDCCH is detected is used to determine whether the target time-frequency resource subset comprises at least one RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: when the reference search space set and the second search space set are the same, whether at least one of the first PDCCH or the second PDCCH is detected is used to determine whether the target time-frequency resource subset comprises at least one RE occupied by the second PDCCH; otherwise, whether the second PDCCH is detected is used to determine whether the target time-frequency resource subset comprises at least one RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: whether the reference search space set and the second search space set are the same is used to determine whether the first PDCCH is used to determine whether the target time-frequency resource subset comprises at least one RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: whether the reference search space set and the second search space set are the same is used to determine whether the detection result of the first PDCCH is used to determine whether the target time-frequency resource subset comprises at least one RE occupied by the second PDCCH.

In one embodiment, the statement in the claims that “whether the reference search space set and the second search space set are the same is used to determine whether the target time-frequency resource subset comprises at least one RE occupied by the second PDCCH” includes the following meaning: whether the reference search space set and the second search space set are the same is used to determine the existence of correlation between whether the target time-frequency resource subset comprises at least one RE occupied by the second PDCCH and whether the first PDCCH is detected.

In one embodiment, the statement in the claims that “whether the reference search space set and the second search space set are the same is used to determine whether the target time-frequency resource subset comprises at least one RE occupied by the second PDCCH” includes the following meaning: when the reference search space set and the second search space set are the same, whether the first PDCCH is detected is used to determine whether the target time-frequency resource subset comprises at least one RE occupied by the second PDCCH; otherwise, whether the target time-frequency resource subset comprises at least one RE occupied by the second PDCCH is unrelated to whether the first PDCCH is detected.

In one embodiment, the statement in the claims that “whether the reference search space set and the second search space set are the same is used to determine whether the target time-frequency resource subset comprises at least one RE occupied by the second PDCCH” includes the following meaning: when the reference search space set and the second search space set are the same, whether the first PDCCH is detected is used to determine whether the target time-frequency resource subset comprises at least one RE occupied by the second PDCCH.

### Embodiment 11

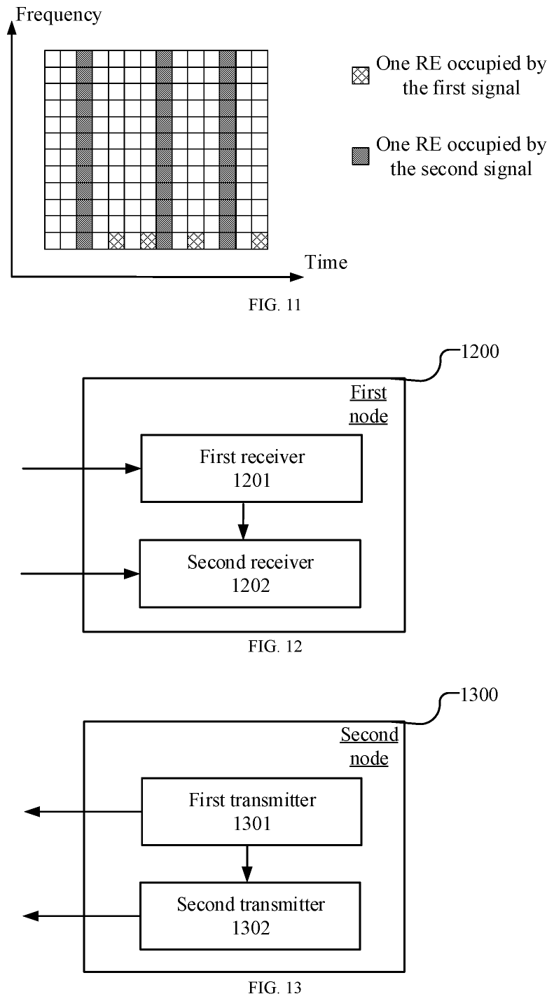

Embodiment 11 illustrates a schematic diagram of a relationship between a first signal and a second signal according to one embodiment of the present application, as shown in FIG. 11. The resource mapping of a first signal and a second signal in one RB in frequency domain and in one slot in time domain is given in FIG. 11, with the horizontal axis representing time and the vertical axis representing frequency, each small square representing an RE, each cross-filled square representing an RE occupied by the first signal, and each dark gray filled small square representing an RE occupied by the second signal.

In Embodiment 11, the second signal in this application occupies a reference time-frequency resource group, the reference time-frequency resource group comprising at least one RE; the first signal and the second signal in this application are two different types of reference signals, and a position/positions of at least one symbol in the reference time-frequency resource group in time domain is/are used to determine a position/positions of at least one symbol occupied by the first signal in time domain.

In one embodiment, the reference time-frequency resource group comprises discrete time-domain symbols in time domain.

In one embodiment, the reference time-frequency resource group comprises consecutive time-domain symbols in time domain.

In one embodiment, the reference time-frequency resource group comprises discrete subcarriers in frequency domain.

In one embodiment, the reference time-frequency resource group comprises consecutive subcarriers in frequency domain.

In one embodiment, any RE comprised in the reference time-frequency resource group belongs to the target time-frequency resource subset.

In one embodiment, the reference time-frequency resource group comprises an RE that belongs outside the target time-frequency resource subset.

In one embodiment, the reference time-frequency resource group and the target time-frequency resource subset are orthogonal to each other.

In one embodiment, there are overlapped REs between the reference time-frequency resource group and the target time-frequency resource subset.

In one embodiment, any RE comprised in the reference time-frequency resource group belongs to the first time-frequency resource set.

In one embodiment, a position of an RE comprised in the reference time-frequency resource group in the first time-frequency resource set is predefined or signaling configured.

In one embodiment, a distribution of REs comprised in the reference time-frequency resource group in the first time-frequency resource set is predefined or signaling configured.

In one embodiment, a distribution of REs comprised in the reference time-frequency resource group in each RB comprised in the first time-frequency resource set is predefined or signaling configured.

In one embodiment, a distribution of symbols occupied in time domain by REs comprised in the reference time-frequency resource group is predefined or signaling configured.

In one embodiment, any RE comprised in the reference time-frequency resource group is occupied by the second signal.

In one embodiment, an RE occupied by the second signal belongs outside the reference time-frequency resource group.

In one embodiment, any RE occupied by the second signal belongs to the reference time-frequency resource group.

In one embodiment, the second signal is a baseband signal or a radio frequency signal.

In one embodiment, the second signal is a Demodulation Reference Signal (DMRS).

In one embodiment, the second signal is a PDSCH DMRS.

In one embodiment, the second signal is a PDCCH DMRS.

In one embodiment, the second signal includes PDSCH DMRS and PDCCH DMRS.

In one embodiment, the first signal and the second signal correspond to a same PDSCH.

In one embodiment, the first signal and the second signal belong to a same PDSCH.

In one embodiment, the first signal and the second signal are used for a same PDSCH.

In one embodiment, the first signal and the second signal are contained in a same PDSCH.

In one embodiment, the first signal and the second signal respectively correspond to different types of channels.

In one embodiment, the first signal and the second signal are respectively used for different types of channels.

In one embodiment, the first signal is used for a PDSCH, while the second signal is used for a PDCCH.

In one embodiment, a type of reference signal to which the first signal belongs is different from a type of reference signal to which the second signal belongs.

In one embodiment, the first signal is PTRS, while the second signal is DMRS.

In one embodiment, the use of the first signal is different from that of the second signal.

In one embodiment, the statement in the claims that “a position/positions of at least one symbol in the reference time-frequency resource group in time domain is/are used to determine a position/positions of at least one symbol occupied by the first signal in time domain” includes the following meaning: the position/positions of at least one symbol in the reference time-frequency resource group in time domain is/are used by the first node or the second node in the present application to determine a position/positions of at least one symbol occupied by the first signal in time domain.

In one embodiment, the statement in the claims that “a position/positions of at least one symbol in the reference time-frequency resource group in time domain is/are used to determine a position/positions of at least one symbol occupied by the first signal in time domain” includes the following meaning: the position/positions of at least one symbol in the reference time-frequency resource group in time domain is/are used to determine a distribution of symbol(s) occupied in time domain by the first signal among symbols comprised in time domain in the first time-frequency resource set.

In one embodiment, the statement in the claims that “a position/positions of at least one symbol in the reference time-frequency resource group in time domain is/are used to determine a position/positions of at least one symbol occupied by the first signal in time domain” includes the following meaning: the position/positions of at least one symbol in the reference time-frequency resource group in time domain is/are used to determine a position/positions of at least one symbol occupied by the first signal in time domain based on predefined pseudo-codes or steps.

In one embodiment, the statement in the claims that “a position/positions of at least one symbol in the reference time-frequency resource group in time domain is/are used to determine a position/positions of at least one symbol occupied by the first signal in time domain” includes the following meaning: the index/indexes of at least one symbol in the reference time-frequency resource group in time domain is/are used to determine an index/indexes of at least one symbol occupied by the first signal in time domain.

In one embodiment, the statement in the claims that “a position/positions of at least one symbol in the reference time-frequency resource group in time domain is/are used to determine a position/positions of at least one symbol occupied by the first signal in time domain” includes the following meaning: the index/indexes of at least one symbol in the reference time-frequency resource group in time domain among symbols comprised in time domain in the first time-frequency resource set is/are used to determine the index/indexes of at least one symbol occupied in time domain by the first signal among symbols comprised in time domain in the first time-frequency resource set.

In one embodiment, the statement in the claims that “a position/positions of at least one symbol in the reference time-frequency resource group in time domain is/are used to determine a position/positions of at least one symbol occupied by the first signal in time domain” includes the following meaning: the first signal occupies multiple symbols in time domain, with an interval length between any two adjacent symbols occupied by the first signal in time domain being not less than a target interval length, the target interval length being a positive integer; and the position(s) of at least one symbol included in time domain in the reference time-frequency resource group is used to determine a maximum value of the interval length between any two adjacent symbols occupied by the first signal in time domain. In one subsidiary embodiment of the above embodiment, the target interval length is related to a modulation and coding method of a PDSCH corresponding to the first signal. In one subsidiary embodiment of the above embodiment, the target interval length is predefined or signaling configured. In one subsidiary embodiment of the above embodiment, the target interval length is related to a modulation and coding method indicated by the target control signaling.

In one embodiment, the statement in the claims that “a position/positions of at least one symbol in the reference time-frequency resource group in time domain is/are used to determine a position/positions of at least one symbol occupied by the first signal in time domain” includes the following meaning: the first signal occupies multiple symbols in time domain, with an interval length between any two adjacent symbols occupied by the first signal in time domain being not less than a target interval length, the target interval length being a positive integer; an interval length between a symbol comprised in the reference time-frequency resource group in time domain and a symbol occupied in time domain by the first signal is equal to the target interval length. In one subsidiary embodiment of the above embodiment, the target interval length is related to a modulation and coding method of a PDSCH corresponding to the first signal. In one subsidiary embodiment of the above embodiment, the target interval length is predefined or signaling configured. In one subsidiary embodiment of the above embodiment, the target interval length is related to a modulation and coding method indicated by the target control signaling.

In one embodiment, the statement in the claims that “a position/positions of at least one symbol in the reference time-frequency resource group in time domain is/are used to determine a position/positions of at least one symbol occupied by the first signal in time domain” includes the following meaning: the first signal occupies multiple symbols in time domain, with an interval length between any two adjacent symbols occupied by the first signal in time domain being not less than a target interval length, the target interval length being a positive integer; a first symbol is a symbol occupied by the first signal in time domain, and a second symbol is a symbol comprised in the reference time-frequency resource group in time domain that is earlier than the first symbol and has a minimum interval length away from the first symbol, where the interval length between the second symbol and the first symbol is equal to the target interval length. In one subsidiary embodiment of the above embodiment, the target interval length is related to a modulation and coding method of a PDSCH corresponding to the first signal. In one subsidiary embodiment of the above embodiment, the target interval length is predefined or signaling configured. In one subsidiary embodiment of the above embodiment, the target interval length is related to a modulation and coding method indicated by the target control signaling.

In one embodiment, a modulation and coding method indicated by the target control signaling is also used to determine the position(s) of at least one symbol occupied by the first signal in time domain.

### Embodiment 12

Embodiment 12 illustrates a structure block diagram of a processing device in a first node in an example, as shown in FIG. 12. In FIG. 12, a processing device 1200 in the first node comprises a first receiver 1201 and a second receiver 1202. The first receiver 1201 comprises the transmitter/receiver 456 (comprising the antenna 460), the receiving processor 452 and the controller/processor 490 in FIG. 4 of the present application; the second receiver 1202 comprises the transmitter/receiver 456 (comprising the antenna 460), the receiving processor 452 and the controller/processor 490 in FIG. 4 of the present application.

In Embodiment 12, the first receiver 1201 receives a first information block, the first information block used to determine a first search space set and a second search space set, the first search space set comprising at least one PDCCH candidate, and the second search space set comprising at least one PDCCH candidate, the first search space set being different from the second search space set; the second receiver 1202 receives a target control signaling and receives a first signal, the target control signaling used to determine a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, a control resource set associated with the first search space set is a first control resource set; a control resource set associated with the second search space set is a second control resource set; quasi co-location of reference signals in the first control resource set is different from quasi co-location of reference signals in the second control resource set.

In one embodiment, an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

In one embodiment, a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

In one embodiment, at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

In one embodiment, the first information block is used to indicate a reference search space set, the reference search space set being one of the first search space set or the second search space set; whether the reference search space set and the second search space set are the same is used to determine whether the target time-frequency resource subset comprises at least one RE occupied by the second PDCCH.

In one embodiment, the second receiver 1202 receives a second signal; herein, the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

### Embodiment 13

Embodiment 13 illustrates a structure block diagram of a processing device in a second node in an example, as shown in FIG. 13. In FIG. 13, a processing device 1300 in the second node comprises a first transmitter 1301 and a second transmitter 1302. The first transmitter 1301 comprises the transmitter/receiver 416 (comprising the antenna 460), the transmitting processor 415 and the controller/processor 440 in FIG. 4 of the present application; the second transmitter 1302 comprises the transmitter/receiver 416 (comprising the antenna 460), the transmitting processor 415 and the controller/processor 440 in FIG. 4 of the present application.

In Embodiment 13, the first transmitter 1301 transmits a first information block, the first information block used to indicate a first search space set and a second search space set, the first search space set comprising at least one PDCCH candidate, and the second search space set comprising at least one PDCCH candidate, the first search space set being different from the second search space set; the second transmitter 1302 transmits a target control signaling and transmits a first signal, the target control signaling used to indicate a first time-frequency resource set, the first time-frequency resource set comprising multiple REs, and the first signal occupying at least one RE in time-frequency domain, any RE occupied by the first signal in time-frequency domain belonging to the first time-frequency resource set; herein, the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

In one embodiment, a control resource set associated with the first search space set is a first control resource set; a control resource set associated with the second search space set is a second control resource set; quasi co-location of reference signals in the first control resource set is different from quasi co-location of reference signals in the second control resource set.

In one embodiment, an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

In one embodiment, a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

In one embodiment, at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

In one embodiment, the first information block is used to indicate a reference search space set, the reference search space set being one of the first search space set or the second search space set; whether the reference search space set and the second search space set are the same is used to determine whether the target time-frequency resource subset comprises at least one RE occupied by the second PDCCH.

In one embodiment, the second transmitter 1302 transmits a second signal; herein, the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node or the second node, or UE or terminal includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), relay satellite, satellite base station, airborne base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block, the first information block being used to determine a first search space set and a second search space set, the first search space set comprising at least one PDCCH candidate, and the second search space set comprising at least one PDCCH candidate, the first search space set being different from the second search space set; and
a second receiver, receiving a target control signaling and receiving a first signal, the target control signaling being used to determine a first time-frequency resource set, the first time-frequency resource set comprising multiple REs, and the first signal occupying at least one RE in time-frequency domain, any RE occupied by the first signal in time-frequency domain belonging to the first time-frequency resource set;
wherein the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

2. The first node according to claim 1, characterized in that a control resource set associated with the first search space set is a first control resource set; a control resource set associated with the second search space set is a second control resource set; quasi co-location of reference signals in the first control resource set is different from quasi co-location of reference signals in the second control resource set.

3. The first node according to claim 1, characterized in that an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

4. The first node according to claim 1, characterized in that a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

5. The first node according to claim 1, characterized in that at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

6. The first node according to claim 1, characterized in that the first information block is used to indicate a reference search space set, the reference search space set being one of the first search space set or the second search space set; whether the reference search space set and the second search space set are the same is used to determine whether the target time-frequency resource subset comprises at least one RE occupied by the second PDCCH.

7. The first node according to claim 1, characterized in that the second receiver receives a second signal; wherein the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

8. A second node for wireless communications, comprising:
a first transmitter, transmitting a first information block, the first information block being used to indicate a first search space set and a second search space set, the first search space set comprising at least one PDCCH candidate, and the second search space set comprising at least one PDCCH candidate, the first search space set being different from the second search space set; and
a second transmitter, transmitting a target control signaling and transmitting a first signal, the target control signaling being used to indicate a first time-frequency resource set, the first time-frequency resource set comprising multiple REs, and the first signal occupying at least one RE in time-frequency domain, any RE occupied by the first signal in time-frequency domain belonging to the first time-frequency resource set;
wherein the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

9. The second node according to claim 8, characterized in that a control resource set associated with the first search space set is a first control resource set; a control resource set associated with the second search space set is a second control resource set; quasi co-location of reference signals in the first control resource set is different from quasi co-location of reference signals in the second control resource set.

10. The second node according to claim 8, characterized in that an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

11. The second node according to claim 8, characterized in that a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

12. The second node according to claim 8, characterized in that at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

13. The second node according to claim 8, characterized in that the second transmitter transmits a second signal; wherein the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.

14. A method in a first node for wireless communications, comprising:
receiving a first information block, the first information block being used to determine a first search space set and a second search space set, the first search space set comprising at least one PDCCH candidate, and the second search space set comprising at least one PDCCH candidate, the first search space set being different from the second search space set; and
receiving a target control signaling and receiving a first signal, the target control signaling being used to determine a first time-frequency resource set, the first time-frequency resource set comprising multiple REs, and the first signal occupying at least one RE in time-frequency domain, any RE occupied by the first signal in time-frequency domain belonging to the first time-frequency resource set;
wherein the PDCCH candidate(s) in the first search space set and the PDCCH candidate(s) in the second search space set are correspondingly associated; a first PDCCH is a PDCCH candidate in the first search space set, while a second PDCCH is a PDCCH candidate associated with the first PDCCH in the second search space set; a target time-frequency resource subset comprises at least one RE other than the RE(s) occupied by the first signal in the first time-frequency resource set; whether the first PDCCH is detected is used to determine whether the target time-frequency resource subset comprises at least one RE occupied by the second PDCCH.

15. The method in the first node according to claim 14, characterized in that a control resource set associated with the first search space set is a first control resource set; a control resource set associated with the second search space set is a second control resource set; quasi co-location of reference signals in the first control resource set is different from quasi co-location of reference signals in the second control resource set.

16. The method in the first node according to claim 14, characterized in that an aggregation level of the first PDCCH is equal to an aggregation level of the second PDCCH, and an index of the first PDCCH in the first search space set is equal to an index of the second PDCCH in the second search space set, and a control signaling carried by the second PDCCH is the same as a control signaling carried by the first PDCCH; whether the first PDCCH is detected is used to determine whether the target time-frequency resource subset comprises at least one RE occupied by the first PDCCH.

17. The method in the first node according to claim 14, characterized in that a target value is equal to a total number of monitorings performed on the first PDCCH and the second PDCCH, the target value being a positive integer; at least one of whether the second PDCCH is being monitored or the target value is used to determine whether the target time-frequency resource subset comprises at least one RE occupied by the second PDCCH.

18. The method in the first node according to claim 14, characterized in that at least one symbol occupied by the second PDCCH in time domain belongs to a first time window, and a subcarrier occupied by the second PDCCH in frequency domain belongs to a first BWP; a first threshold is equal to a maximum number of PDCCH monitorings performed by a receiver of the target control signaling within the first time window and on the first BWP, the first threshold being a positive integer; a second threshold is equal to a maximum number of non-overlapped CCEs occupied by PDCCH candidates monitored by the receiver of the target control signaling within the first time window and on the first BWP, the second threshold being a positive integer; the second search space set, the first threshold and the second threshold are used together to determine whether the second PDCCH is being monitored.

19. The method in the first node according to claim 14, characterized in that the first information block is used to indicate a reference search space set, the reference search space set being one of the first search space set or the second search space set; whether the reference search space set and the second search space set are the same is used to determine whether the target time-frequency resource subset comprises at least one RE occupied by the second PDCCH.

20. The method in the first node according to claim 14, characterized in comprising:
receiving a second signal;
wherein the second signal occupies a reference time-frequency resource group, the reference time-frequency resource group comprising at least one RE; the first signal and the second signal are two different types of reference signals, and a position/positions of at least one symbol in the reference time-frequency resource group in time domain is/are used to determine a position/positions of at least one symbol occupied by the first signal in time domain.
